(19) United States
(12) Patent Application Publication
(10) Pub. No.: US 2003/0208397 A1
(43) Pub. Date: Nov. 6, 2003

(54) Method of doing business and security instrument

(76) Inventor: Dennis A. VanDusen, Chevy Chase, MD (US)

Correspondence Address: Law Office of Jerome D. Jackson, Suite 100, 211 N. Union Street, Alexandria, VA, 22314, US

(21) Appl. No.: 09/843,752

(22) Filed: Apr. 30, 2001

Related U.S. Application Data
(60) Provisional application No. 60/201,303, filed on May 2, 2000.

(51) Int. Cl. G06F 17/60

(52) U.S. Cl. 705/14

(57) ABSTRACT

Disclosed are a method of doing business and a security instrument. An exemplary method includes creating an equity pool with a plurality of equity interests; and compensating an associate, who has completed a milestone of a project, with a portion of the equity pool. An exemplary security instrument includes an equity pool and a security interest in the equity pool.

### 1. SCOPE

This document provides a list of high-level business functions of an internet website strategy. These business functions have been developed by Dennis Van Dusen.

1.1 Identification

This Business Functions Report (FR) applies to the development of an internet website and an information delivery strategy.

1.2 System Overview

1.3 Document Overview

This document enumerates business functions for the effort as found by Dennis Van Dusen thus far in the requirements definition phase of the project. The Business Functions Report contains the following sections:

1. Scope. This section is divided into the following paragraphs.

1.1 Identification. This paragraph contains a full identification of the system and the software to which this document applies, including, as applicable, identification number(s), title(s), abbreviation(s), version number(s), and release number(s).

1.2 System overview. This paragraph briefly states the purpose of the system and the software to which this document applies. It describes the general nature of the system and software; summarizes the history of system development, operation, and maintenance; identifies the project sponsor, acquirer, user, developer, and support agencies; identifies current and planned operating sites; and lists other relevant documents.

1.3 Document overview. This paragraph summarizes the purpose and contents of this document and describes any security or privacy considerations associated with its use.

2. Referenced documents. This section lists the number, title, revision, and date of all documents referenced in this specification. This section also identifies the source for all documents not available through normal Government stocking activities.

3. Business functions. This section is divided into the following paragraphs to specify the High Level Business Functions in the system. Each business function has been assigned a project-unique identifier to support traceability.

3 Alpha List of Business Functions

3.1 E-Effort Management

E-Effort Networks, Inc. is set to become an affordable provider of web development to new website owners and to small and growing entrepreneurial web ventures in the Baltimore-Washington area.

It will provide website development, web database management, and web hosting services to clients on a fee basis. For a select set of clients, E-Effort Networks, Inc. will also provide assistance with business systems and capital investment acquisition in exchange for fees and/or an equity stake in the client.

E-Effort Networks, Inc. will capture web development market share by being the low-cost provider in the region, leveraging its low overhead E-Effort (virtual teamwork) environment. This environment consists of a small core management team and a distributed network of IT professionals organized through a sophisticated web-based project management system. Initially, the IT professionals will consist of off-hour professionals and top-tier university students.

E-Effort Networks, Inc. will provide web development and/or business development services for two types of clients:

1. Businesses that participate on a cash payment basis. These will include full web development and “surge” development projects. These sites are expected to be relatively simple in nature in most cases.

2. Incubated Ventures that participate in return for partial or full payment in equity.

The E-Effort Task Management System is a web based system for task assignment, bidding, and management. This system allows prequalified IT and Electronic Graphic Design professionals to bid on task assignments, complete project management updates, and receive compensation while working in their own environments.

E-Effort Networks, Inc. will provide web development services to its customers with freelance and student developers managed using a Lotus Notes-based project management tool to track client website development task progress. E-Effort Networks, Inc. management will solicit clients and draft contracts for work with existing companies for cash and with startups for a cash-equity mix. Projects are expected to be surge work and web development for existing businesses, and web development for startups.

3.1.1 Task Management for Website Build Tasks

The E-Effort Task Management System is a web based system for task assignment, bidding, and management. This system allows pre-qualified IT and Electronic Graphic Design professionals to bid on task assignments, complete project management updates, and receive compensation while working in their own environments.

E-Effort Networks, Inc. will provide web development services to its customers with freelance and student developers managed using a Lotus Notes-based project management tool to track client website development task progress.

Deliverables, In General

Description of Result Contents

Contact Information

Status Information

Issues/Problems List

Limitations List

Zip of Results, with proper directory structures

New Information regarding task

3.1.1.1 Site Construction Tasks

planning a site, designing it, actually building it, effectively promoting it and growing its capabilities

3.1.1.1.1 Site Design

If you created a solid business plan, you have already done much of the work of designing your site. For example, you have already selected applications, determined the site goals, done your resource planning, and selected the design and development tools.

As you continue to design your site, remember that truly great web applications are, above all else, practical. That means they are well planned, easy to use, easy to maintain, intuitive, open (they support most browsers without plug-ins), relevant, and addictive.

Prototyping and testing are important components of the design phase. Your prototype lays the groundwork for later versions. Testing will uncover the positive and negative aspects of your site before you go live.

Additional resources:

Philip and Alex's Guide to Web Publishing

Yale Web Style Guide

Jakob Nielsen's Website (www.useit.com)

3.1.1.1.1.1 Preliminary Site Planning

designing the site navigation, linking external systems and databases, or analyzing the effectiveness of the site

Considering site performance issues

3.1.1.1.1.2 Site Concept Development

3.1.1.1.1.2.1 Site Story

3.1.1.1.1.2.2 Site Storyboard

An outline or list of pages in the current site and what their purpose is

3.1.1.1.1.2.3 Site Purpose Statement

3.1.1.1.1.2.4 Enumerate Participants

Enumerate the Spectrum of Participants

State who the constituents of the website are and what they get out of the site.

State how the constituents get value from the site.

3.1.1.1.1.2.5 Site Participant and Role Model

Specify all types of users and their expected activities. Classify who each type of user is and what they want from the system.

3.1.1.1.1.3 Site Architecture Development

3.1.1.1.1.3.1 Site Object Model

Define the Site Object Model—the set of components that model the information and processes used to run the Web business.

A site object model is a collection of ContentObject Types. Each object type contains a set of properties and methods. Properties are the elements of data associated with an object type. For instance, a product object type might have SKU, Name, Price and Category as properties. Methods are the activities that surround the object, such as create, display and order. The code that manages the activities is built using ColdFusion. The proper ties of information or data can be stored and managed by the content manger, using the ContentObject database, or in any external RDBMS accessed via SQL or object middleware.

3.1.1.1.1.3.2 Site Layout Model

Site Layout Model Development

The site layout model describes the site's navigation, branding, and look and feel. The site layout begins with an overall navigation structure for a site by defining the overall site structure, including site sections and pages. It also provides a means for control over access and security, site and page-wide logging and caching behavior.

Site Layout Tool

While the goal of an interactive developer is to build the core objects used for managing and deploying site assets, the goal of the site designer is to create a layout model for the site's navigation, branding and look and feel. The site layout tool enables site designers to create an overall navigation structure for a site by defining the overall site structure, including site sections and pages.

More importantly, site designers can define site and section-wide page templates that contain the site's layout and graphic elements. These HTML page templates are then used to create new pages in the site. Using this aspect of the site layout tool, companies can empower business users to create new sections and pages in a site without knowing HTML, while simultaneously enforcing common branding and look-and-feel requirements.

Additionally, the site layout tool coordinates in controlling over all access and security. For example, perhaps only product managers can update pricing pages on the site. Also, through this, it is easy to configure site and page-wide logging and caching behavior.

Deliverables (Need work)

Page type to Storyboard Matrix

Frame Structure to Storyboard Matrix

Goal: Work packages for Page Content

3.1.1.1.1.3.3 Search and Indexing Goals

Once a company moves to managing its core content and commerce assets in a common repository, it becomes dramatically easier to index and search that content. This task provides a description of the use of any of a rich set of search and index capabilities based on an embedded search engine.

Developers will configure the properties in their site to be searched, whether directly through a custom search application such as a search form for rental information in a real estate portal, or on a site-wide basis, for example a search box on a home page that allows end users to search all content in the site.

3.1.1.1.1.3.4 Site Content Metadata Model

Site Content Metadata (Site Categories)

A key component of a broad content management solution is the strategic use of metadata, or what we call site categories. Metadata is used to tag, or mark content items with data that identifies the types of content in use. Metadata provides the foundation for a range of other capabilities, including higher level end user browsing and searching tools, user interest profiling, and rich reporting on which classes of content and products are most popular in a Web site.

Site category Metadata allow developers and business users to define categories and keywords that any piece of content can inherit. For instance, for a sports portal, a set of common categories that content can inherit include sport, league, team, player and writer. Any given piece of content in the portal could be about one or more sports, leagues, teams or players, and each item would typically have a writer or author.

When business users add new content items to the system, they apply site category metadata information to the items. Once this is done, it becomes easier for end users to find information of interest to them. For instance, an end user of the portal can request all items about a given sports team, or all articles about a given league written by a given author. Likewise, because every piece of content that an end user views is tracked, it becomes easier to create a specific profile of that user. Using this profile, we can personalize content and product information shown to end users based on custom rules defined by interactive developers and business managers.

3.1.1.1.1.3.5 Role-Based Security Model

Specify all types of users and their scope of site related activities. Classify who each type of user is and what they are allowed to do in the system.

3.1.1.1.2 Website Development

During the development phase, you will use HTML and JavaScript for client-side development, and PL/SQL and Perl for server-side development (both CGI and cartridges). Most projects are a combination of the two. You must develop file system operations against the Web server or against the data server. This is the phase when you will implement the plans you made during the business phase to address cookies and ports/security issues. Now is also the time to develop a library of routines including a generic error routine. Additional resources:

The JavaScript Resource (www.serve.com)

Internet.com (www.internet.com)

IDM's list of development tools (www.idm.internet.com)

Inquiry.com (www.inquiry.com)

3.1.1.1.2.1 Site Testing Tasks

Testing, Debugging, and Tuning

The next step is testing, debugging, and tuning. Keep in mind that your site requires more testing than standard business applications and must encompass testing back-end (server) code, checking browser (client) variations, investigating network issues, and solving security problems. During your testing consider the browsers you will support, your network and modem speeds, and any reliance on Java, JavaScript, and cookies since individual users have the ability to modify many of these aspects. When tuning for throughput, address the following areas:

balance processing between client and server

offload FTP, mail, and database services to other servers

generate static HTML for standard reports using UTL_FILE, DBMS_JOBS

check regularly to make sure your site is up

tune the cartridge instance parameter accordingly

use Net.Medic to analyze your network

Don't forget application tuning of SQL queries, PL/SQL and PL/SQL packages, CGI, Perl, and other dynamic programs. And last, but not least, tune your site's graphics by reducing the color count and using thumbnails when possible.

3.1.1.1.2.1.1 Load and Performance Testing

3.1.1.1.2.1.2 Functional Testing

3.1.1.1.2.1.3 Regression Testing

3.1.1.1.2.1.4 Scenario Testing

3.1.1.1.2.1.5 System Modeling

3.1.1.1.2.1.6 Unit Testing

3.1.1.1.2.2 Client Development Tasks

3.1.1.1.2.3 Server Development Tasks

3.1.1.1.2.4 Back Office Development Tasks

Building and Linking external databases into site

3.1.1.1.2.5 Network Development Tasks

3.1.1.1.2.6 Object Server Development Tasks

Buliding and Linking external object database items into site

3.1.1.1.2.7 Database Population

creating and editing site content or product information, Database Loading and Data Entry Deliverables

Data populated into database, according to description and forms provided (((Data Discovery Tasks will also be needed)))

3.1.1.1.2.8 Breakdown Web Devel Tasks for Effort—E-Effort

3.1.1.1.2.9 Programming

3.1.1.1.2.10 Database Development

3.1.1.1.2.11 Graphics Development

3.1.1.1.2.12 Site Localization

3.1.1.1.2.13 Component Integration

3.1.1.1.2.14 Write Product Description

3.1.1.1.2.15 Edit and Revise Copy

Deliverables

Copy written in plain text or on a prescribed word processor, with some formatting allowed—including paragraph marks, hyphen placements (optional and non-breaking), but not full html.

3.1.1.1.2.16 Capture Image

Deliverables

Image in prescribed format and size.

3.1.1.1.2.17 Page Design

3.1.1.1.2.18 User Authentication

One of the most common features of a Web system is a means for authenticating end users of the site or application. Whether for an intranet where access to certain content is required, or for members of a public Internet site or e-commerce portal, authentication is needed to identify users and map those users to profiles and security policies.

A configuration tool for user authentication is needed. Authenticated users must be tied to a user profile, and their session information must be automatically tracked throughout the system.

3.1.1.1.2.19 Activity-Based Access Control

An Activity-based access control model allows interactive developers and business managers to collaborate in defining how security is applied to different activities involved in managing the Web business. In developing a site object model using the COAPI, an interactive developer is implicitly defining the categories of assets and the activities that can be performed on those assets. For example, sports articles can be created, edited, displayed, etc. This granular definition maps cleanly to the activity-based access control model. A business manager can simply apply a new policy to a content type, and the system will automatically enforce this business rule. For example, a business manager might define a set of policies for controlling the management and creation of product promotions. The policy might say that any end user (even anonymous end users of the Web site) can view any promotion. However, only sales managers can create and edit promotions, while sales directors can approve a promotion for deployment on the Web site. It also specifies the mapping of user roles to activities surrounding management of the overall site layout, such as creation of sections, pages, and page templates. A wide-range of user activities involved in the back-office side of the Web site are also managed using activity-based access control policies.

3.1.1.1.2.20 Membership Database Development

While the production and management of the Web business is certainly a major area of focus for security, so too is the public face of the Web system. Ultimately, Web systems are customer facing, whether those customers be internal employees, external suppliers and partners, or literal customers using your Web site to access products and services. The website thus must support your customers through the use of membership databases.

Membership databases are technically no different than other user directories. Their security policies are defined and applied in exactly the same manner as for back-office users. However, they are crucially different in terms of how companies store and manage this information. Unlike user directories for internal management functions (such as NT Domains and LDAP directories), membership databases often already exist in the form of customer accounts and customer databases.

There is thus a need to support the integration of existing customer and membership directories through an open interface. For instance, a major airline may already have a customer database for its frequent flyer program. Rather than creating an entirely new customer database for its Web portal, the airline simply maps this customer database to the user authentication engine provided with/by the website.

Open User and Policy Databases

System administrators and interactive developers must configure the website security to use an existing corporate user directory. These might be existing NT Domains, LDAP Directories (which includes most mail servers and Novell NDS directories) and custom SQL-based user directories. Likewise, policy databases might be stored in any standard relational database or an LDAP directory.

3.1.1.1.2.21 Site Personalization

Personalization is one of the foundations of successful Internet businesses. At the same time, it is one of the most misunderstood and underleveraged capabilities. Personalization services can provide companies with a three-tier personalization model that starts with simple capabilities, and grows more complex as the sophistication of the Web business grows.

User Profiling

Basic personalization starts simply. The most common form of personalization is keeping a user profile record in a Web system. User profiling allows you to store and track simple or complex values associated with a given user. These values are then available to interactive developers and business managers for creating dynamic content for each user.

Common user profile values might include name, country, email address, etc, which could be used to greet the user by name, or dynamically show them content in their local language. More complex user profile values might include a list of favorite writers or favorite foods. Very complex values include multiple shipping and billing addresses. The User Profile tool allows you to store any number of simple or complex values and associate them with a given user.

A common application of user profiling would be creating a personalized MyPage for your portal or Web site.

User profiles can contain either explicit or implicit information. Explicit information is information that is supplied by the end user. Most tools for user profiles support the World Wide Web Consortium (W3C) standard for user profiles, the Platform for Privacy Preferences or P3P. This includes common elements such as name, address, billing information, shipping information, etc. In addition, developers can create implicit profile data, which is data generated from user interactions with the system.

Rules-Based Personalization

A more advanced and increasingly more common form of personalization is rules-based personalization. This is a framework for dynamically targeting content and product offers to end users using rules.

Usually, a very granular, event logging model that tracks users activities as they move throughout a Web site is best. This logged information is processed, matching items the user viewed to more explicit information about those items, and then generating weighted values, which are stored in the user profile.

Business users and managers can then use the content delivery features to define rules that map a user profile to specific content publishing rules. For example, a business manager might use a rule that shows only news content to a user that matches a user's category interests.

Allaire Spectra rules-based personalization dramatically expands the scope of how companies can dynamically target content and information to end users. However, Allaire Spectra recognizes that every business is differ--ent, and information about a user and the activities and interests they have will typically map to custom busi--ness rules. Because of this, the Allaire Spectra rules engine is easily customizable. Interactive developers can work with business managers to define the kinds of rules that are relevant to their business, and can leverage the same granular data as the native rules provided with Allaire Spectra.

Advanced Personalization Architecture

Allaire Spectra personalization features are designed based on a best-practices architecture for personalization. This architecture allows for maximum interoperability and integration with leading advanced personalization engines, such as Net Perceptions, Andromedia LikeMinds, and Bowne OpenSesame. The Allaire Spectra personalization architecture focuses on the synergy of four key systems: user profiling, object logging, site categories, and rules-based content delivery. User profiling provides a user-specific data base for storing profile data. Object logging tracks the user's events and activities. Site categories provide rich contextual information about the content types those activities contained. And rules-based content delivery allows for precise targeting of content based on the melding of the above three systems.

3.1.1.1.2.22 Site Syndication Services

Syndication—a system for extending your Web business to Internet business partners and other Web sites Syndication

As corporations have invested in the Web over the past few years, they've quickly learned that one of the biggest assets of the Web are the other Web sites and companies on the Web. Corporations are beginning to understand that Internet-centric business requires building business models centered around relationships established between Web sites. Syndication services focus on enabling business models that leverage site-to-site relationships to drive business. Whether for an extranet-based supply-chain integration application, or an online e-commerce affiliate network, Syndication forms the backbone of rich content and enterprise application integration efforts.

Site Affiliates

Just as your Web systems have standard end users or site members, in the age of syndication, your Web systems have site affiliates. Site affiliates are just another class of end user of your system. Site affiliates are assigned a default member group.

Site affiliates are your Internet-based business partners. These could be explicit sales and supplier partners for your existing business, or new partners forged through the Web, supplying you with Web content or leveraging the content and transactions on your site. Each site affiliate receives a unique username and password, which then allows either an individual or a remote program to request or submit information to and from your Web systems.

Application Syndication

Once you've identified your site affiliates, the next step is to expose to them the specific information and applications required for your syndication relationship. Remote site automation allows you to expose elements of your site object model to site affiliates.

For instance, you may have a product catalog in your site object model. This product catalog allows for browsing and searching, and for the taking of product orders on your system. Each of these activities is exposed automatically via your site object model. With remote site automation, you can selectively expose functionality of your system to remote applications, no matter what platform the affiliate is using.

Remote site automation allows you to transparently expose your site infrastructure through an open, WDDX-based API, allowing almost any remote application environment, including ColdFusion, ASP, Java servlets, Perl, PHP, etc. to invoke searches and retrieve data from your system. Because your site affiliate is a member of a specific user group, you can restrict activities using security policies in the same manner that you restrict end user activities in your system.

The Syndication Model

Most syndication models focus on static content sharing, which is usually insufficient. Dynamic content syndication embraces the idea that your site affiliates will want to build custom applications that dynamically invoke and integrate your site assets—exchanging data, searching, and conducting transactions. In short, the same process and model you use for building your site object model with the COAPI serves as the foundation for new site relationships built on syndication.

Content Syndication

While the cutting-edge of the Internet economy may involve real-time remote site automation and syndication, the more practical problem that must be solved is simple content sharing and exchange between Web sites.

Content syndication services provide a simple model to syndicate content to and from any Web site, no matter what the format or delivery vehicle used. There are two primary modes of content syndication: inbound and outbound.

Inbound content syndication involves bringing outside content into your Web systems in an automated fashion. For instance, your Web site might want to automatically retrieve a news feed from a remote site, convert it, and insert that content into the content manager database. Inbound content is managed by subscriptions created by interactive developers. Each subscription has a provider, a schedule, and custom handlers. The source may be another HTTP server, an email server, or an FTP address. The schedule defines how frequently to poll for new content. And the custom handlers provide code to process the inbound content. For complex inbound content, interactive developers would leverage ColdFusion's native string and text parsing tools to retrieve the appropriate data. Of course, if inbound content were in XML or WDDX format, it will be much easier to insert this content into the system.

Business managers can also create subscriptions to other syndicated servers, where syndicating content on a scheduled basis is extremely simple, hopefully requiring no custom coding by interactive developers.

Outbound content syndication is also very easy to setup and manage. Site affiliates log into your system and use the same Relevant Access tools provided to internal business users and managers. Using content delivery configuration tools, site affiliates can define what types of content and what rules to use to provide that content. Site affiliates define a schedule, and method of delivery for the content (SMTP, HTTP, FTP).

The same site object model and display templates used for delivering content to end users on your site can be reused to deliver versions of content to site affiliates, ensuring that your syndicated content maintains your own brand or look and feel, if desired.

3.1.1.2 Quality Assurance Management

3.1.1.2.1 Development Metrix

Business Intelligence

Delivering a rich repository of site information, Allaire Spectra's business intelligence services provides the means for business managers to make on-the-spot decisions, placing the Web business heads above the competition.

Observation Architecture

Granular logging of all user activities and events, including paths of interest that users follow within the system. Fully definable activity tracking—e.g. track content edits, views, and scheduling. Complete audit trails provides information about the production and publishing of site assets. Session path logging allows business managers to understand the navigational flow of users throughout the site.

Reporting Center

Accessible via the Allaire Spectra Webtop, the Reporting Center provides customizable views into the success of your business. View standard site activity reports like number of hits, most popular pages & content items, navigation paths and user demographics. Fully customizable reporting environment provides the flexibility to visually select and process specific log file data, or build custom SQL queries.

Advanced Business Intelligence Solutions

Allaire Spectra works with industry-leading eBusiness Intelligence tools like WebTrends, Andromedia Aria and net.Genesis' net.Analysis. By integrating directly into the Observation Architecture, these tools provide comprehensive views into the success of your Web business.

3.1.1.2.2 Site Style Replication

Syndication

Leading the way in the new Internet economy, Allaire Spectra provides the industry's most advanced set of features for enabling companies to establish new relationships and new ways of doing business on the Web.

Site Affiliates

Default member group “Site Affiliate” allows you to easily set up Internet-based business partners for leveraging and sharing content and transactions on your site. Each Site Affiliate is given a unique user id and password allowing them to submit remote program requests or submit information to and from your site.

Remote Site Automation

Transparently expose your site infrastructure through an open, XML-based API allowing interaction with any remote application environment such as ColdFusion, ASP, Java, Perl, PHP, etc. Expose specific site functionality to your Site Affiliates like site object searching or the ability to remotely initiate and transact a product order.

Content Exchange

Share content to and from any Web site, no matter what the format or application environment. Bring outside content into your system from sources like news feeds or stock quotes, and poll for new content on a scheduled basis. Expose your site assets to Site Affiliates allowing them to subscribe and define the schedule and format for delivery on their site.

3.1.1.2.3 Methodology Improvement

3.1.1.2.3.1 Retain Results of Prior Efforts as Templates for New Effort

3.1.1.2.3.2 Maintain a Record of Corporate Experience and Skills

3.1.1.2.4 Methodology Development

3.1.1.2.4.1 Task Template Definition

Define Task Templates for specific task types during work breakdown

3.1.1.2.5 Score Technical Staff or Teams on Work Product

TPMs score technical staff or teams on work product. Scores determine the nature and amount of new work assigned to each developer. High scorers will have priority for work assignments and receive more complex tasks.

3.1.1.3 Site Deployment Tasks

3.1.1.3.1 Website Implementation

Now you're ready to implement your site. Keep in mind that although it may be easy to refine your web application once it's been implemented, it is considerably less costly (about 1,000 times less expensive in fact) to make modifications to a design document. Address all the aspects of security, from protection from physical tampering/environmental disasters to network firewall to proxy server. We highly recommend that you develop a written security policy. After the site is up and running, your Web Listener log files and data you store about your dotcom users/customers can provide you with some useful marketing-analysis information. You should be able to pull the following information from your site about your site visitors:

demographics—gender, race, age, education, home value, family size, income

personality profiles—self-concept, attitude, interests, opinion, beliefs, preferences, personality traits

web-surfing patterns—attention span, focus, appetite, impulsiveness, judgment, analytical skills

You can use this information for predictive marketing, helping you increase page hits and sales.

The last item, under the support and maintenance umbrella, is determining the methods by which your users can receive support. Will customers e-mail, phone, or fax in their problems—or will they have all three options? Determine the turnaround time for each method and establish policies.

Rules-based content delivery allows for precise targeting of content based on the melding of the above three systems.

3.1.1.3.2 Continuing Site Development

It's important to determine the steps you'll use to implement changes to your Web site. You should define a policy on change control. There's no need to keep reinventing the wheel, and you will insure uniformity for future changes.

And, in addition to planning how to change your current site, you need to plan for the long term as well. The future will bring faster networks and cheaper memory. Technology is changing so rapidly that it's difficult to predict what will come down the road in the next 10, 25, or 50 years. What you really need to focus on is Web site development and how quickly you can implement change. Where are you today? Where do you want to go? What do you need to be aware of?

Three key concepts to take into consideration as you plan for the future:

Forrester Reports defines transactive content as the future of the dotcom—you can read more on their Web site

Web sites will need to incorporate interpersonal skills

Thin-client computing is here to stay

3.1.1.3.2.1 Site Maintenance

3.1.1.3.2.2 Site Extension

3.1.1.3.3 System Administration

3.1.1.3.4 Network Administration

3.1.1.3.5 Content Delivery Specification

Another aspect of content management for business users is a set of tools for defining how content is delivered. While site designers create the actual page templates that control where pages live in a site, what pages look like and what they can contain, business users and managers use tools to define and control what specific items are published live in the Web site. Business users must pre-select items to be published, assign publishing schedules to these items, and pick from pre-defined publishing rules to dynamically determine what content items are displayed to end users.

For instance, on a sports portal, the editor of a column of news content on the home page could pre-select two items to show up on the home page, scheduling them to start at 8AM the next morning, and end two days later. The editor might also pick a rule that dynamically shows the two most popular news items (based on click-throughs), and another rule that picks content that matches the end user's sport league preference, for example if their favorite sport is professional basketball, two recent articles about the NBA would show up.

While granular control over what items are dynamically published is extremely powerful, it can also be costly in terms of performance. To address the needs of high volume Web sites, users will control caching behavior at many levels of granularity. They will configure caching on an item-by-item basis, by region of a page, for example to cache only one section of a page, but make another section dynamic, at a full page level, to cache all of the contents in a page, effectively delivering the page with the same performance as a static HTML file, or at the section level, to cache all pages in a certain section.

Additionally, browser context must be managed through a set of browser bindings configured through the Webtop. Through browser bindings, interactive developers can target different views of a content item based on a given browsers' capabilities, such as whether the browser supports Cascading Style Sheets or only HTML 3.2 fonts.

3.1.1.4 Site Reporting and Measurement Tasks

3.1.1.4.1 Transaction Management and Monitoring

3.1.1.4.2 Access Control

3.1.1.4.3 Usage Metering

Business intelligence is the basis upon which a website's success or failure is measured. This requires the tracking of site activity and an extensible analysis and reporting model, companies can develop a thorough understanding of their Web business.

Observation and Tracking

Observation requires highly granular logging of all user activities and events, including detailed information about the paths that a user follows through the system. Object logging tracks the user's events and activities. Site categories provide rich contextual information about the content types those activities contained. Object logging enables interactive developers and business managers to collaborate to determine which activities to track. For example, they could decide whether to track all content views and content changes, or just content views, as well as what additional information they need to cull together from the logged data in order to track the most popular content on the site.

Back-office operations tracking data, such as changes and deletions to items, is needed to build custom system audits, which provide reports on which business users are most actively managing what data. Session path logging allows business managers to understand how users are navigating through their site, which paths are most common, and then to use that information to modify the site navigation.

Reporting

Reporting serves as the business managers' view into their Web business. The Reporting tool provides a common environment for viewing and creating custom reports. Business managers can configure log file processing rules, allowing them to control what information they want to garner from the user activity. From this processed information, they can either view standard reports, or create their own reports based on custom queries. Standard reports include common site activity, such as number of hits, most popular pages, and path tracking, that is, the most common paths through the site. The tool must also report on end user content interests, such as the most popular content types, and user demographics. Custom reports can be built using either a set of user-interfaces for selecting elements to process and search, or by directly processing the log file data and creating custom SQL queries against that data. Reports generated on a custom basis can still be viewed and accessed directly from within the Reporting tool.

Business intelligence allows business users or managers to view reports on content and user activity from directly within a page. For example, a business manager would go to a page and immediately get a report on the number of users who viewed that page within a set period of time. They will drill down further to see where the users came from, and what the primary click-throughs from that page were.

3.1.2 Manage Content and Assets for Projects

The Content Manager allows diversely skilled and distributed teams to control, coordinate and collaborate within the Web site creation process. The Content Manager uses an object store as the repository to manage all creative assets, including image files, Java applets, HTML pages, source code, and others. The features of the Content Manager include asset check-in/check-out, version control, basic approval workflow and Web rendering. Control information allowing access according to where we are in the process and who we are.

Content Management

Workflow and Process Automation

Roles-Based Security

Personalization

Business Intelligence

Syndication

Content Management

Rich and powerful content management allows for managing vast quantities of content and commerce assets.

ContentObject Database

Transparent storage & retrieval of site information shielding developers from complex SQL programming. Native support for popular content types including files, images, Flash animations, RealMedia and other embedded objects. Advanced storage & caching mechanism facilitates lightning-fast response times and granular control over how content is served—static or dynamic. Built-in archiving with full search & indexing capabilities.

Anywhere Authoring

Empowers business users with the ability to create and manage content in the Web site without direct involvement from IT or HTML developers. Browser-based, in-context publishing provides an intuitive environment whereby content creation, editing, scheduling and analysis is performed in the context of the Web site itself. Built-in, rich-text HTML editor for authoring content directly within a browser.

Site Layout Model

Provides Site Designers with an advanced model for visually defining site navigation and placement of content and commerce assets. Define site and section-wide page templates containing layout and look-and-feel elements for use throughout the site. Empower business users to create and deploy new sections and pages of the site based on templates provided by Site Designers.

Search & Indexing

Based on ColdFusion's built-in Verity search engine, content and commerce assets are immediately available for searching and retrieval. Granular control over what information and what properties of content are searchable on a site-wide basis.

Site Categories

Apply Site Category information (meta-data) to content and commerce assets for enabling categorical site-wide searches. Personalize content and product information to end-users based on custom rules that utilize customer profile and site category information.

Content Delivery

Comprehensive Web-based tools for business users to manage the scheduling & delivery of site assets. Assign custom publishing rules like “prime time”, “top-of-the-hour”, “weekly” and “holidays”). Personalize information delivery through assignment of simple rules that govern the types of information viewed by end users (e.g. five most popular news articles, user's favorite category).

3.1.2.1 Test Site Build

3.1.2.1.1 Directory Build

3.1.2.1.2 Database Build

3.1.2.1.3 Request Test Site Build

3.1.2.2 Final Site Build

3.1.2.2.1 Directory Deploy

3.1.2.2.2 Database Deploy

3.1.2.2.3 Request Site Build

3.1.2.2.4 Instantiate Site Database

3.1.2.3 Site Save

The site import function allows developers to save existing file-based Web sites to the content database by importing a site from the file system. The site can then be entered into the workflow, messaging and security mechanisms.

3.1.2.4 Site Access for Builds

Provide security, directory and routing for users of test directories and sites.

3.1.2.5 Workflow Based Access

Controls site development content through their life cycle from authoring to review, approval, distribution and archiving.

Workflow and Process Automation

Allaire Spectra offers a flexible, yet powerful environment for establishing and managing common business practices and processes on the Web.

Workflow

Create customizable workflow templates for managing the creation and deployment process for content and product items. Associate workflow templates with particular site assets (e.g. the creation of a product promotion, press release or the handling of an incoming customer service request). Asynchronous, multi-person, multi-task dependency support. Task escalation and prioritization capabilities. Task notifications communicated via email, fax, pager or web phone.

Process Automation

Designed to handle the management and execution of linear or serial processes, Allaire Spectra's Process Logic Path (PLP) technology provides an environment for handling wide ranges of activities like complex commerce transactions or simple online registration processes. Visually define required steps in the process along with the associated data required for completion of each step. Automatic state management provides a mechanism for preserving processes in the event of a lost connection. Link external sources like customer databases and ERP systems incorporating information and logic into the overall PLP requirements. Check for availability of inventory, validate a credit card or update a general ledger system with a recorded sale at the completion of a PLP. Full control over error and exception handling with rollback capability.

3.1.2.6 Establish Asset Management for Results of Effort

3.1.2.7 Configuration Management, Build Management and Component Asset Management for Results of Effort

3.1.3 Contributor Management

Directory system for managing large-scale, professional on-line communities. It offers a secure and customizable environment to allow the shared use of information or application across the Web. Each member of the community can be profiled so information can be targeted at the right people. All will benefit from more timely and more efficient communication, information sharing and processes.

Personalization

A three-tier model provides organizations with a simple, yet powerful means for applying site-wide personalization of content and product information for customers and site members.

User Profiling

Track and store user information for use in the delivery of customized content and product information. Define any number of member attributes for tracking and storage.

Rules-Based Personalization

Using natural language type rules, business users can target content and product information based on user profiling and user activity information gathered from the system. Define custom rules for delivering information that matches user interests.

Advanced Personalization

Fully operable with leading personalization and collaborative filtering engines such as Net Perceptions, Andromedia LikeMinds and Bowne Open Sesame. Open architecture exposes user profile, logging and Site Category (meta-data) information for simple access and custom integration.

3.1.3.1 Contributor Qualification Tasks

3.1.3.1.1 Determine Skill Level of Applicants

3.1.3.1.2 State Skill Set

3.1.3.1.3 Check Skill Set

3.1.3.1.4 Describe Context of Test, Including Environment, Interfaces, Timeframe, Deliverables, Performance Procedures, Grading Procedures

3.1.3.1.5 Take a Task as a Qualification Test of Skill Level

3.1.3.1.6 Grade Test, and Retain Results

3.1.3.1.7 Publish Results of Qualification Tests to Selected Recipients

3.1.3.1.8 Retain Performance Information for Contributors On Prior Efforts

3.1.3.1.9 Advertise Skills and Availability; Publish Resume

3.1.3.1.10 Get others to Publish Contributors Resume

3.1.3.1.11 Maintain a Record of Skills

3.1.3.1.12 Maintain a Resume Database

3.1.3.1.13 Maintain a Record of Individual Contributor Skills

3.1.3.1.14 Maintain a Record of Customer Satisfaction with Individual Efforts

3.1.3.1.15 Maintain a Record of Individual Certifications

3.1.3.1.16 Take a Test as a Qualification Test of Skill Level

3.1.3.1.17 QA Grades Task, and Retains Results

3.1.3.2 Compensation Management

Compensation for E-Effort staff will be based on a points-based cafeteria-style plan. Freelancers will accrue points based on job performance, critical skills, leadership, innovation and other key criteria for each project on a task milestone completion basis and expire one year from the date of issue. Points can be redeemed for cash, equity, cooperative education credits, or any combination of the three. Redemption of credits will be governed by certain guidelines. Initially, an auction market for the E-Effort tasks will determine compensation levels for tasks. Compensation is granted for work that has passed quality assurance or an integration stage. Tasks completed to a qualifying level will yield other benefits to the performer, including follow-on development work for the project. High scorers will be eligible for certain bonuses.

Points Negotiable—based upon:

Completion Time

Skill Availability

Task Difficulty

Points Conveyed/Awarded-based upon:

Milestones Reached ˜30%

Customer Acceptance ˜30%

Project Completion ˜30%

Deal Harvesting Value Events ˜10%

3.1.3.2.1 E-Equity for Redemption of Compensation Points

3.1.3.2.2 Convert Points to Cash Compensation

3.1.3.2.3 Calculate Contributor Compensation

3.1.3.2.4 Get Paid in Points (Non-Cash) Compensation for Task Completion

3.1.3.2.5 Obtain Tools for Development and Contributing

3.1.3.2.6 Redeem Compensation Points Via E-Commerce

3.1.3.2.7 E-Commerce for Redemption of Compensation Points

3.1.3.2.8 E-Education for Redemption of Compensation Points

3.1.3.2.9 Redeem Compensation Points Toward Equity

3.1.3.2.10 Redeem Compensation Points for Education

3.1.3.2.11 Compensation Back to Parent Company for Employees

3.1.3.2.12 Entry into Parent Company Accounting and Payroll Systems

3.1.3.3 Contributor Training

scalable and flexible web-based course delivery.

3.1.3.3.1 Introduce Contributor to Methodologies

3.1.3.4 Contributor Communication

3.1.3.4.1 Enroll as an E-Effort Contributor

3.1.3.4.2 Contributor Outreach Programs

3.1.3.4.3 Contributor RealTime Communication

application sharing, electronic whiteboarding, and awareness, control passing, and sharing native Web content.

3.1.3.4.4 Offline Contributor Communications

extends real-time awareness(find me), conversation (tell me) and object sharing (show me) collaborative possibilities beyond hallway encounters, telephone calls, and face-to-face exchanges by allowing contributors to find colleagues on-line in an instant.

3.1.3.4.5 Publicize Existence/Purpose of E-Effort

3.1.3.4.6 Learn of E-Effort System

3.1.3.4.7 Learn of Recruiter

3.1.3.4.8 Learn of Opening for Full Time

3.1.3.4.9 Learn of Task Availability

3.1.3.4.10 Describe Positions (for Full Time Employees)

3.1.3.4.11 Publicize Opening (for Full Time

3.1.3.4.12 Publicize Task Availability (for Effort—E-Effort Only)

3.1.3.4.13 State Interest in Being Informed about Availability of Full Time Positions

3.1.3.4.14 State Interest in Being Informed about Availability of Tasks

3.1.3.4.15 State Interest in Specific Full Time Position

3.1.3.4.16 State Interest in Specific Body Shop 1099 FT, Short Duration Position

3.1.3.4.17 State Interest in Specific Task Completion Effort

3.1.3.4.18 Describe Context of Work Tasks, Including Environment, Interfaces, Timeframe, Deliverables, Compensation Expectations, Contact Points, Procedures

3.1.3.4.19 Publish Results of Tasks to Selected Recipients for Use in other Tasks

3.1.3.4.20 Have Continuing Involvement in Task or Team

3.1.3.4.21 Have Continuing Involvement in Resulting Site

3.1.3.4.22 Publicize Existence/Purpose of Recruiter

3.1.3.4.23 Collect Contributor Information

3.1.3.4.24 My Page Setup

MyPage provides an end user with links to favorite content or parts of the site. MyPage values, such as the types of items a user wants to track, could be specified by the end user and then stored in a user profile. When an end user requests their MyPage, the application retrieves the relevant user profile data, and builds the page on the fly for that user.

3.1.3.4.25 Archive Contributor Correspondence, Including announcements

3.1.3.4.26 Archive Customer Correspondence

3.1.3.5 Contributor User Interface

Contributor User Interface

As a personalized, roles-based productivity work center, the Contributor User Interface is at the center of the Web business for building, managing and carrying out the day-to-day tasks associated with the business. Whether you're a business manager analyzing site success or a Site Designer tasked with creating new site-wide branding, the Webtop provides the necessary tools and functionality for participants to carry out their specific role in the business.

Anywhere Management

Accessible from any Web browser anywhere, the Contributor User Interface provides a unified and personalized environment for each participant managing your Web business. The Contributor User Interface must be open and customizable enabling you to deliver organization-specific look-and-feel and end user functionality.

User Assistance

Embedded throughout the Webtop, rich media types like Flash, and RealAudio aid participants with carrying out specific tasks within the E-Effort environment. Browser-based help with powerful search capabilities provides advanced assistance for all participants in the system.

Contributor User Interface Syndication

In addition to a set of core productivity tools, the Contributor User Interface delivers personalized, dynamic, knowledge-based content like “Product News”, “Product Tips”, “How To's”, “Software Update Notices”, etc. all syndicated from the E-Effort.Net web site and other informational sources.

3.1.3.6 Task Flow Management

This task defines the surrounding process management for each type of website design/development task.

3.1.3.6.1 Subtask RE-Definition and Project Management

3.1.3.6.1.1 PM RE-Specifies Risks, Obstacles, Issues in the Subtask RE-Definition

3.1.3.6.1.2 PM Assembles, Revises, and Checks Context Material in the Subtask RE-Definition

3.1.3.6.1.3 PM RE-Breaks Down Subtask Based Upon Scope and Workability of Subtask as Presented

3.1.3.6.1.4 PM RE-Details Deliverables and Configuration Items for Subtask

3.1.3.6.1.5 PM Creates Modified Template for Work Effort on Subtask

3.1.3.6.1.6 PM Re-Checks Modified Subtask Statement and Changes to Determine Consistancy with Parent Task

3.1.3.6.1.7 PM Extends Changed Subtask Definition as Needed to Fully Define Role of Contributors to Subtask Effort

3.1.3.6.1.8 PM Creates New Subtasks of this Changed Subtask if Effort for this Task Would Require More than 6 Hours. Create New Task Control Form for Each New Subtask.

3.1.3.6.2 QA of Subtask RE-Definition—Test for Completness of Material

3.1.3.6.2.1 Score the Subtask RE-Definition Project Management Task Results

3.1.3.6.2.2 QA RE-Specifies Risks, Obstacles, Issues in the Subtask RE-Definition

3.1.3.6.2.3 QA of Subtask RE-Definition—Test for Workability and Scope of Planned Subask

3.1.3.6.3 Notification of New Subtask Effort Requirement

3.1.3.6.4 QA of Results for Changes in Subtask Effort Requirement

3.1.3.6.5 Integration of Results for Changes in Subtask Effort Requirement

3.1.3.6.6 Milestone for Changes in Subtask Effort Requirement

3.1.3.6.7 Record Compensation Event for Milestone Acceptance on Changed Subtask Effort

3.1.3.6.8 Milestone Acceptance on Subtask Effort

3.1.3.6.8.1 PM Determines Completion Based upon Integration, QA Eval

3.1.3.6.8.2 PM Determines Winners Depending upon Several Factors

3.1.3.6.8.3 PM Determines Detailed Compensation Qualifications

3.1.3.6.8.4 PM Evokes Compensation Model Triggers

3.1.3.6.8.5 Customer Accepts/Ranks Subtask Configuration Items/Deliverables

3.1.3.6.8.6 PM Prepares Acceptance Package for Customer

3.1.3.6.9 Record Compensation Event for Milestone Acceptance on Subtask Effort

3.1.3.6.10 Trial Integration of Subtask Effort

3.1.3.6.11 Notification of Changes in Subtask Effort Requirement

3.1.3.6.12 Perform on Changes in Subtask Effort Requirement

3.1.3.6.12.1 Submit Results for Changes in Subtask Effort Requirement

3.1.3.6.13 Notification of Subtask Initial Completion

3.1.3.6.14 Notification of Subtask Effort 1st Submission

3.1.3.6.15 Notification of Subtask Final Completion

3.1.3.6.16 QA of Subtask Definition—Test for Completness of Material

3.1.3.6.16.1 Score the Subtask Definition Project Management Task Results

3.1.3.6.16.2 QA Specifies Risks, Obstacles, Issues in the Subtask Definition

3.1.3.6.16.3 QA of Subtask Definition—Test for Workability and Scope of Planned Subask

3.1.3.6.17 Sign-Up for Subtask Effort

3.1.3.6.17.1 Make Bid Guess on Subtask Work Package

3.1.3.6.17.2 Complete Subtask Performance Signup Process

3.1.3.6.17.3 Pass Qualification Tests and Skills Confirmation

3.1.3.6.18 Subtask Definition and Project Management

3.1.3.6.18.1 PM Specifies Risks, Obstacles, Issues in the Subtask Definition

3.1.3.6.18.2 PM Assembles and Checks Context Material in the Subtask Definition

3.1.3.6.18.3 PM Breaks Down Subtask Based upon Scope and Workability of Subtask as Presented

3.1.3.6.18.4 PM Details Deliverables and Configuration Items for Subtask

3.1.3.6.18.5 PM Creates Template for Work Effort on Subtask

3.1.3.6.18.6 PM Re-Checks Subtask Statement to Determine Consistancy with Parent Task

3.1.3.6.18.7 PM Extends Subtask Definition as Needed to Fully Define Role of Contributors to Subtask Effort

3.1.3.6.18.8 PM Creates New Subtasks of this Subtask if Effort for this Task Would Require More than 6 Hours. Create New Task Control Form for Each New Subtask.

3.1.3.6.18.9 Re-Estimate Subtask Time Requirements

3.1.3.6.18.10 Estimate “Nominal” Points to Be Issued for Compensation

3.1.3.6.18.11 Determine Compensation Posture for Subtask Effort Based upon Need Date, etc.

3.1.3.6.18.12 Determine Compensation Plan for Subtask Work, Including Phased Compensation Plan

3.1.3.6.18.13 Determine Milestone Structure fore Subtask Effort.

3.1.3.6.19 Perform RE-Authorizations, etc for Developer.

3.1.3.6.20 Change Notice Accepted on Subtask Deliverable

3.1.3.6.21 Confirm Readiness to Perform on Changes in Subtask Effort Requirement

Confirm Readiness to Perform on Changes in Subtask Effort Requirement

3.1.3.6.22 Perform Authorizations, etc for Developer.

3.1.3.6.23 Perform Subtask Effort

3.1.3.6.23.1 Submit Subtask Effort Deliverables, Comments, PM Forms, and Results

3.1.3.6.23.2 Complete Process Management Subtask Information Sheet

3.1.3.6.23.3 Attach All Deliverable Documents, Programs, Art, etc. to Process Management Information Form, etc.

3.1.3.6.23.4 Understand All Context Documents, Requirements for Deliverables Such As Programs, Art, etc.

3.1.3.6.23.5 Perform Actual Subtask Effort Such As Programming, etc. to Produce Deliverables.

3.1.3.6.23.6 Attempt to Access All Systems Being Granted Access to as Soon as Possible After Authorization.

3.1.3.6.23.7 Report Any Problems Regarding the Task ASAP Using the Subtask Performance Issue Template.

3.1.3.6.23.8 Submit a Subtask Performance Status Information Sheet When Task is Being Performed but Is Taking Longer than Planned. State Reasons when Possible.

Submit a Subtask Performance Status Information Sheet when task is being performed but is taking longer than planned. State reasons when possible.

3.1.3.6.23.9 Hold on the Effort Whenever a Subtask Performance Requirement Change Issue or Completion Notice for Subtask Is Received

3.1.3.6.24 QA on Subtask Effort

3.1.4 Project Control

Deliverables

Description of Result Contents

Contact Information

Status Information

Issues/Problems List

Limitations List

Zip of Results, with proper directory structures

New Information regarding task

3.1.4.1 Establish Tracking for Re-Certify Effort

3.1.4.2 Calculate Metrics of Re-Certify Efforts as Management Tool

3.1.4.3 Incubator Project Management

Deliverables—Plans and Requirement Statements, with completed checklists:

Internal Management Responsibilities

Context and Contact Information

Contracts

Work Breakdowns and Customer Responsibilities

Due Date Expectations

Priorities Evaluations

Point Estimate Evaluations

Populated ‘Notes’ for Subtask Packages

Infrastructure Requirements and Plans

3.1.4.3.1 Mentoring

3.1.4.3.2 Back Office System Provision

3.1.4.3.3 Triage Control

3.1.4.3.4 Harvesting Control

3.1.4.3.5 Deal Analysis

3.1.4.3.6 Deal Making and Description

Deal Identity

What is the name of the deal

Contact name

Contact phone

Email

Address

What is the nature of the business? The business model? Has similar model been in the incubator before? Is this deal a sale of Surge services or an incubator effort? What is the status of the deal team:

Funded? Sponsored? To what degree?

Part of another organization?

Other Qualification Questions

What is site to be developed to include?

Components

New technology

Graphics

Home Page

Database

Will any part of site be usable for later deals? What are expectations of other part regarding the E-Effort Networks involvement?

Financial Expectations/Capital Investment

Ownership Level

Mentoring

Site Component Ownership

Marketing Involvement

Hosting

Servers

Space

Management

Raising Capital

How far has the entrepreneur gotten on their own?

Plan

Site structure

Marketing

Team Formation

Site Story and/or Storyboards

Site Design

Site 1st Cut

3.1.4.4 Surge Task Management

Deliverables—Plans and Requirement Statements, with completed checklists:

Internal Management Responsibilities

Context and Contact Information

Contracts

Work Breakdowns and Customer Responsibilities

Due Date Expectations

Priorities Evaluations

Point Estimate Evaluations

Populated ‘Notes’ for Subtask Packages

Infrastructure Requirements and Plans

3.1.4.4.1 Task Marketing and Description

3.1.4.5 Billing

3.1.4.6 Establish Control for Effort

Deliverables Reviews of Plans and Requirements, with completed checklists:

Internal Management Responsibilities

Context and Contact Information

Contracts

Work Breakdowns and Customer Responsibilities

Due Date Expectations

Priorities Evaluations

Point Estimate Evaluations

Populated ‘Notes’ for Subtask Packages

Infrastructure Requirements and Plans

3.1.4.7 Establish Tracking for Recruiting Effort

Deliverables Entry into Project Management Tool, of Plans and Requirement Statements, with completed checklists:

Internal Management Responsibilities

Context and Contact Information

Contracts

Work Breakdowns and Customer Responsibilities

Due Date Expectations

Priorities Evaluations

Point Estimate Evaluations

Populated ‘Notes’ for Subtask Packages

Infrastructure Requirements and Plans

3.1.4.8 Time and Materials Control for Effort

3.1.4.9 Progress Tracking for Effort and Deliverables Completion

Deliverables, In General

Contacts made Information

Status Information, including projections to completion, resources used, needed

Issues/Problems List

Limitations List

New Information regarding task

3.1.4.10 Retain Metrics of Prior Efforts as Management Tool for New Effort

3.1.4.11 Calculate Metrics of Recruiting Efforts as Management Tool

3.1.4.12 Get Paid for Recruitment

3.1.4.13 Get Paid for Job Completion

3.1.4.14 Monitor and Manage Project Task Progress

Review of:

Contacts made Information

Status Information, including projections to completion, resources used, needed

Issues/Problems List

Limitations List

New Information regarding task

3.1.4.15 Evaluation Phase

Business Prospect Qualification

Compensation/Investment/Payment Potentials

Financial Needs/Opportunities

Fit/Management Team Evaluation

Value Event Determination

Evaluate

Business—Value Definition/Value Points

Market—Customer Definition (Need Statements); Marketing Plan review

Story—Purpose, Perspective, Perception for Website

Long Term/Short Term Impact on Sentient, Team Business Deal

Compensation Plan

Investment/Payment Agreements

Team Structure

3.1.4.16 Design Phase

State Requirements

Story Board for Site

Development Element Definition

Value Point Analysis

Customer Need Analysis

Infrastructure Requirements

Other Support Requirements

Initiate Design

Project Package Development

Infrastructure Plan Development

Build Plan Development

Data Object Definition

3.1.4.17 Build Phase

Design Metrics for Site

Determine Sizzle, Fun Points

Implement Story Board for Site

Data Object Detailing

Develop Site Elements

Build Out Infrastructure

Evaluate and Improve

Measure against Value Point Analysis

Measure against Customer Need Analysis

Review against Sizzle, Fun Points, Ease of Use, etc.

Review Original Marketing Plans for Web Firm

Review Value Event Potentials

3.1.4.18 Launch Phase

Launch

Marketing Support

Review

Compensation Plan Execution

Reconsider Value Event Potentials

Reconsider Methodologies

Determine Continuous Improvement Goals

3.1.4.19 Scale Phase

Scale

Review Scalability Gauges, Metrics and Issues

State Environment Needs

State Other Dependencies

State Other Impacts

Implement Continuous Improvement Plan

Profitability

Foster Value Event Potentials

Alter Web Firm Marketing Plans and Foster Changes

3.1.5 Customer Coordination

E-Effort Networks, Inc. will provide web development services to its customers with freelance and student developers managed using a Lotus Notes-based project management tool to track client website development task progress.

E-Effort Networks, Inc. management will solicit clients and draft contracts for work with existing companies for cash and with startups for a cash-equity mix. Projects are expected to be surge work and web development for existing businesses, and web development for startups.

3.1.5.1 Analyse Incubator Candidate

3.1.5.2 Contact E-Effort Networks

3.1.5.3 Business Preparation Phase

Preparing the Business for Developing, Deploying, Promoting, and Managing a Website

3.1.5.3.1 Refining the Idea

Some ideas are born in a single “eureka” moment. For example, you're shopping for a wedding gift for a friend and it occurs to you that it would be convenient if the bride and groom put their gift registry online. Then, friends and family could simply browse through the gift selection at their leisure and use secure credit card transactions to buy the newlyweds exactly what they want.

Other ideas are hammered out over long periods of time. For example, you might find a small gap in a business or service you use every day and brainstorm for weeks before creating an online solution to the problem.

The idea phase should encompass not only the concept, but objectives and strategies as well. Are you selling your own product or someone else's product? What kind of sales volume do you anticipate? How much time and resources do think it will take to maintain and support your dotcom?

Even if your idea is only on a cocktail napkin, it's a good idea to go ahead and select a domain name, determine if it's available, and register it.

3.1.5.3.2 Creating A “No Brainer” Business Case

The most effective approach to moving from concept to an actual venture is what we call the “no-brainer” business case. This step involves building a presentation of your concept that is capable of convincing customers, investors, and employees that your idea is a “no brainer”. In other words, there exists a clear, unmet, and large customer need and a clear path to making your idea into a viable business. It must be obvious how you will turn your idea into a real business. During this phase, you should take the time to formulate your concept into something you can explain easily (the 2-minute elevator pitch). Mark Twain once wrote a long letter in which he implied that if he had more time, he would have written a shorter letter. In other words, it can take a lot of time to make the complex sound simple.

The first step in building a compelling no-brainer case is to build the customer case. Determine and explain why anyone would want your services (that is, define the value proposition). Include cost and time savings that your potential customers will realize, since the appeal of a product is relative to the customer's costs.

Is this a new product or service venture? If so, focus on how you will use technology to drive real business-process innovation in the industry, not just provide another method of doing the same things. Does your product or service require any behavioral changes on the customer's part? Keep in mind that behavioral changes are difficult to justify to potential investors.

After building the customer case, develop a business case showing that you have found a real business or profit opportunity. You should focus on understanding the size of the market, potential competitors, and the general profit potential of the business. To build a business case, you must:

research the size of the market

define your revenue model (for example, will your derive income from subscription, licensing, gross sales, or advertising?) and how you will price your service

estimate fixed and variable costs of your business

determine what your market share must be to show a profit If you determine that you need a market share greater than 15-20%, beware. In fact, even a 5% level of market penetration is extremely difficult to achieve. Most sophisticated investors are looking for markets bigger than $10 billion (the low bar), so if you plan to search for venture capital, be prepared.

Additional resources:

Business case and research site (www.brs-inc.com)

Case study examples (www.solutionmatrix.com)

3.1.5.3.3 Creating Your Business Plan

The business plan, which represents a road map for a successful venture, is the all-important presentation you'll be taking to potential investors to finance your dotcom. We won't go into the details of the business plan, since numerous resources are available to assist with this. If this is your first foray into the world of business, you may want to consider finding a business advisor or consultant to work with you on your business plan. To build a compelling, investor-ready business plan, you must first spend time on research and personal interviews. It can take up to eight months or even longer (working nearly full time) to gather enough information to write a complete plan, depending on how well you know your subject matter. It's difficult, if not impossible, to conduct your research while retaining other full-time employment. You may have to consider living without income during this phase. Depending on your situation, this may be too high-risk for you.

Your business plan should include:

a comprehensive timeline

standards you'll employ

the software and hardware you'll use to run and maintain your e-business

the software and hardware you will use to develop your e-business

whether you'll develop all of your software or buy some

the ISP or other technology service providers you will contract

a marketing plan

The timeline: Your business plan must include a well thought-out timeline for launching and growing the venture. This timeline will include your plans and milestones for developing the product. For example, months one through six might include something like this:

Month 1: Create a storyboard of the product or service. Your storyboard should include a review of your technical architecture, including the open architectures (CORBA, Unix, TCP/IP). Explain why your choice is scalable, reliable, and recoverable—and why these are important. Show how it is a proven technology and how it is portable across platforms. Also demonstrate that it has high availability, which is where an Oracle-based solution comes into play.

Month 2: Determine functionality for your prototype (document management, profiling, etc.). Determine the components that can be purchased as opposed to built, and negotiate with hardware and software vendors. Select a team for design, development, and graphics. Develop a detailed product schedule for your first release of the “real” thing and a high-level project schedule for future releases. Complete and approve the design of your dotcom.

Month 3: Complete development, including unit testing and complete system testing of the prototype.

Month 4: Release the prototype.

Month 5: Incorporate changes into the prototype based on feedback from beta testers. Prepare for production release.

Month 6: Release the final version.

The standards: Determine the industry standards that your solution will adhere to. For example, create a drawing that shows the n-tier architecture of your dotcom. This basic drawing will bring together the technical architecture in an easy-to-understand way for your potential investors.

When settling on standards, you should also examine the browser you will use and what it encompasses. For example, you may opt to use HTML and JavaScript, cookies for storing encrypted user IDs, limited plug-ins (for example, Adobe Acrobat Reader), limited Java, and perhaps XML later. Explain why your choice is bandwidth-friendly and why this is important. For example: “Our site will have a dialup focus, small graphics, and a low color requirement.”

Finally, don't overlook security standards, for example, SSL, application authentication, domain and IP restriction, basic and digest authentication, and database user authentication. Be prepared to discuss the firewall security as well.

Software and hardware: In your business plan, describe the software you will use to run your dotcom—for example, Oracle 8i RDBMS, Oracle Application Server, Java and PL/SQL, XML and Net8, SSL, and the Apache Web Listener. Be prepared to defend your choice of sofware. For example, you might choose Oracle 8i because of its many Internet-optimization features such as the Oracle iFS; a Java VM in the database; seamless interactions between Java, SQL, and PL/SQL; SQLJ which is embedded SQL in Java; enhanced JDBC drivers; and Web monitoring capabilities.

You must also determine the hardware you will use initially (for example, Intel multiprocessor Pentium), and the long-term solution (for example, Sun, Solaris 2.6+). Demonstrate how you will scale up your hardware and how quickly and easily it can be done.

Development software and hardware: Your business plan should include the development tools you'll use, such as Oracle Application Server and the Java, PL/SQL, Perl or LiveHTML cartridge, Oracle Designer for CASE/Modeling, Macromedia Dreamweaver for HTML Development, Tool for Oracle Application Developers (TOAD) or another PL/SQL editor, WebAlchemy for converting HTML to PL/SQL, WebTrends for site analysis and Oracle Reports as your Reporting Tool.

Build or buy: Include information on whether you will buy or build pieces of your dotcom solutions. We suggest building only if there is nothing—or no reasonably priced solution—available to buy. With the numerous products available on the market today, you should be able to buy most, if not all, of the software for your site. Your job will be to put it all together.

Site hosting: Review where your site will be hosted and why. It's a good idea to find an ASP (Application Service Provider) close to the Internet backbone (and therefore fast) with 24×7 system support, mission-critical redundancy, and backup and recovery capabilities.

Create a marketing plan: In your business plan, include a comprehensive market analysis and marketing plan. You have to know the market you are about to enter. Set specific goals and develop strategies for how to reach those goals. Determine how you will advertise and promote your dotcom. Afterall, the success or failure of a business often hinges on marketing. The potential investors will all ask you how you plan to penetrate the market you're going after. Are you going after a consumer market? If so, creating a consumer-based brand name in the dotcom space today can cost far in excess of $20 million.

Additional resources:

Business Plan Pro (www.palo-alto.com)

Planware (www.planware.org)

Plan Magic (www.planmagic.com)

Inc.com (www.inc.com)

Web Site 101 (www.website101.com)

3.1.5.3.4 Finding Financing

With a detailed, thoughtful business plan in hand, you can move to one of the most critical phases of building your dotcom—finding financing. To get your venture off the ground, you must have an appropriate level of financial resources. Depending upon the scope of your enterprise and your ambitions, funding could run into the millions of dollars. Where are you going to get millions of dollars? How do you find the right people to talk to? Who you talk to, and what you talk to them about depends on the type of financing you're looking for. The financing types correspond to the stages of e-business development:

Seed stage

First round stage

Late stage

Pre-IPO stage

Although non-VC private equity firms, and investment banks are funding more and more startups, in general, there are two basic types of investors you'll talk to during each of the stages listed above: the angel investor and the venture capital (VC) firm. An angel investor is generally an indivdual or small group of individuals who invest their own capital into a venture in return for direct involvement with the company and part ownership.

A venture capitalist generally tends to be a more passive partner, and will also expect a return on an investment in the form of company stock.

The seed (early) stage: During the seed stage, or early stage, you try to raise money to prove your concept. You are probably at the seed stage if you're starting from an idea on a cocktail napkin or have a basic prototype, and need money to:

conduct research

travel to meet customers and potential customers

hire consultants to help in various areas

continue developing the customer/business cases

You might need $100,000 (more if you need to spend money on technology) just to do the necessary research to determine if your business concept is viable. At this stage, you could approach either a venture capitalist or angel investor. Keep in mind that angel investors typically invest less that 1 million dollars, though a group of angel investors together might invest significantly more.

First round: If you have a proven concept are looking for funds to launch your business, you're at the first-round of financing (later rounds of financing will be used to grow the business.) Specific venture capital firms often prefer to provide financing for a specific stage of the business, so you should focus on investors interested in your particular business stage (see the links under Additional resources).

The amount you should try to raise depends on how much money proving and launching your concept really takes; for example, using expensive technology may require more. This phase represents the greatest risk for investors, but if it is successful, it is where the greatest amount of financial value (and personal reward) is created.

Given the amount of risk at this stage, if you can't prove the concept, you lose the entire investment, and the amount of support the entrepreneur requires (patient investors, investors with experience in the space with contacts, knowledge, ideas, and so on), this is not a prudent time to take more money from friends and family.

Late and pre-IPO: Many start ups will go through multiple rounds of financing before their initial public offering (IPO). You may be able to return to your initial investors and convince them to invest again, or you might decide to include additional VC firms.

You find investors the way you find all business contacts: through existing contacts. It is rare to have success by simply shipping a business plan around without direct exposure to the investors receiving it (unless the entrepreneur has a notable reputation). Investors have too many promising opportunities at the present time. If an entrepreneur doesn't have many contacts (entrepreneurs who are real techies may fit this description), you might consider using a service professional (lawyer, accountant, business consultant, or other professional contact) to help you by engaging their contacts for you, by calling on your behalf or sending your business plan directly to the targeted investors. Another option is to employ a fundraiser who will work for a percentage, but finding a good fit for your working style might be more difficult using this approach.

When an investor believes in your business concept, it's time to have him or her buy into the company. The central discussion regarding an investment will be about what is called a pre-money or pre-financing valuation of the company. The pre-money valuation is defined as the value of your venture immediately prior to acceptance of a round of financing. With a solid customer and business case, a good business plan, and a few key members of the management team identified, your venture already has a value, and this valuation will be heavily negotiated during the financing process. The value ultimately determines the percentage of the company an investor receives in return for the money invested, which in turn determines the investor's return on that investment in the future (usually when the venture is sold or has its IPO).

It is important to understand what factors influence valuations. Basically, investors at each stage are looking for a return commensurate with their risk. For example, an investor willing to invest $1 million in an early stage might desire a future return of 10 times her initial investment, or $10 million. If the $1 million is the only sum of startup capital you require, and you predict the venture will harvest $100 million, the investor must receive 10% of the company to achieve her goals.

Often, an e-business will need additional investors in later stages, so the initial investor must plan for future dilution. For example, after the $1 million is spent you require another $10 million. The second round investors may request 30% of the company beyond the dilution of the initial investors (as well as the founder and employees). In this example, the initial investor's original 10% stake would be diluted to 7% after the second round of financing, and now the venture must harvest $142 million to return 10 times the original investment. Projections such as these must be part of the initial valuation (and all subsequent valuations).

Additional resources:

Vfinance.com (www.vfinance.com)

Money Hunter (www.moneyhunter.com)

Finance Hub (www.financehub.com)

Venture Funding Reinvented Red Herring Magazine

3.1.5.3.5 Staffing a Management Team

As part of the business phase, you need to determine who will staff your e-business venture initially, and where you fit in. Will you be the CEO, CIO, or some other senior management member? If you and your partners possess strong technical skills but relatively few business and management skills, you should probably consider rounding out your initial staff roster with a seasoned people-manager.

3.1.5.3.6 Stating Goals

Set Your Goals

What do you want people to be able to accomplish in your presentation? Are your readers looking for specific information on how to do something? Are they going to read through each page in turn, going on only when they're done with the page they're on? Are they just going to start at your home page and wander aimlessly around, exploring your “world” until they get bored and go somewhere else?

As an exercise, come up with a list of several goals that your readers might have for your Web pages. The clearer your goals, the better.

For example, say you were creating a Web presentation describing the company where you work. Some people reading that presentation may want to know about job openings. Others may want to know where you're actually located. Still others may have heard that your company makes technical white papers available over the Net, and they want to download the most recent version of a particular one. Each of these is a valid goal, and you should list each one.

For a shopping catalog Web presentation, you might have only a few goals: to allow you readers to browse the items you have for sale by name or by price, and to order specific items'once they're done browsing. For a personal or special-interest presentation, you may have only a single goal: to allow your reader to browse and explore the information you've provided.

The goals do not have to be lofty (“this Web presentation will bring about world peace”) or even make much sense to anyone except you. Still, coming up with goals for your Web documents prepares you to design, organize, and write your Web pages specifically to reach those goals. Goals also help you resist the urge to obscure your content with extra information.

If you're designing Web pages for someone else—for example, if you're creating the Web site for your company or if you've been hired as a consultant, having a set of goals for the site from your employer is definitely one of the most important pieces of information you should have before you create a single page. The ideas you have for the presentation may not be the ideas that other people have for the presentation, and you may end up doing a lot of work that has to be thrown away.

3.1.5.3.7 State Specifics of Website Project

Designing a Web presentation, like designing a book outline, a building plan, or a painting, can sometimes be a complex and involved process. Having a plan before beginning can help you keep the details straight and help you develop the finished product with fewer false starts. Put together a simple plan and structure for creating a set of Web pages, including

Deciding what sort of content to present

Coming up with a set of goals for that content

Deciding on a set of topics

Organizing and storyboarding the presentation

With that plan in place, you can move on to the specifics of how to write individual Web pages, create links between them, and add graphics and media to enhance the presentation for your audience.

3.1.5.3.7.1 Break Up Content into Main Topics

Break Up Your Content into Main Topics

With your goals in mind, now try to organize your content into main topics or sections, chunking related information together under a single topic. Sometimes the goals you came up with in the previous section and your list of topics will be closely related. For example, if you're putting together a Web page for a bookstore, the goal of being able to order books fits nicely under a topic called, appropriately, “Ordering Books.”

You don't have to be exact at this point in development. Your goal here is just to try to come up with an idea of what, specifically, you'll be describing in your Web pages. You can organize things better later, as you write the actual pages. For example, say you were designing a Web presentation about how to tune your car. This is a simple example since tune-ups consist of a concrete set of steps that fit neatly into topic headings. In this example, your topics might include

Change the oil and oil filter

Check and adjust engine timing

Check and adjust valve clearances

Check and replace the spark plugs

Check fluid levels, belts, and hoses

Don't worry about the order of the steps or how you're going to get your reader to go from one section to another. Just list the things you want to describe in your presentation. How about a less task-oriented example? Say you wanted to create a set of Web pages about a particular rock band because you're a big fan and you're sure there are other fans out there who would benefit from your extensive knowledge. Your topics might be

The history of the band

Biographies of each of the band members

A “discography”—all the albums and singles the band has released

Selected lyrics

Images of album covers

Information about upcoming shows and future products

You can come up with as many topics as you want, but try to keep each topic reasonably short. If a single topic seems too large, try to break it up into subtopics. If you have too many small topics, try to group them together into some sort of more general topic heading. For example, if you were creating an online encyclopedia of poisonous plants, having individual topics for each plant would be overkill. You could just as easily group each plant name under a letter of the alphabet (A, B, C, and so on) and use each letter as a topic. That's assuming, of course, that your readers will be looking up information in your encyclopedia alphabetically. If they want to look up poisonous plants using some other method, you would have to come up with different topics. Your goal is to have a set of topics that are roughly the same size and that group together related bits of the information you have to present.

3.1.5.3.7.2 Get Site Concept Started

When you write a book, a paper, an article, or even a memo, you usually don't just jump right in with the first sentence and then write it through to the end. Same goes with the visual arts—you don't normally start from the top left corner of the canvas or page and work your way down to the bottom right.

A better way to write or draw or design a work is to do some planning beforehand—to know what it is you're going to do and what you're trying to accomplish, and to have a general idea or rough sketch of the structure of the piece before you jump in and work on it.

Just as with more traditional modes of communication, writing and designing Web pages takes some planning and thought before you start flinging text and graphics around and linking them wildly to each other—perhaps even more so, because trying to apply the rules of traditional writing or design to online hypertext often results in documents that are either difficult to understand and navigate online or that simply don't take advantage of the features that hypertext provides. Poorly organized Web pages are also difficult to revise or to expand.

Some of the things you should think about before you begin developing your Web pages are:

Learn the differences between a Web presentation, a Web site, a Web page, and a home page.

Think about the sort of information (content) you want to put on the Web.

Set the goals for the presentation.

Organize your content into main topics.

Come up with a general structure for pages and topics.

After you have an overall idea of how you're going to construct your Web pages, you'll be ready to actually start writing and designing those pages.

3.1.5.3.7.3 Organize Content Concepts for Navigation

Ideas for Organization and Navigation

At this point you should have a good idea about what you want to talk about and a list of topics. The next step is to actually start structuring the information you have into a set of Web pages. But before you do that, consider some “standard” structures that have been used in other help systems and online tools. This section describes some of those structures, their various features, and some important considerations, including

The kinds of information that work well for each structure

How readers find their way through the content of each structure type to find what they need

How to make sure readers can figure out where they are within your documents (context) and find their way back to a known position

Think, as you read this section, how your information might fit into one of these structures or how you could combine these structures to create a new structure for your Web presentation.

Many of the ideas in this section were drawn from a book called Designing and Writing Online Documentation by William K. Horton (John Wiley & Sons, 1994). Although Horton's book was written primarily for technical writers and developers working specifically with online help systems, it's a great book for ideas on structuring documents and for dealing with hypertext information in general. If you start doing a lot of work with the Web, you might want to pick up this book; it provides a lot of insight.

Hierarchies

Probably the easiest and most logical way to structure your Web documents is in a hierarchical or menu fashion. Hierarchies and menus lend themselves especially well to online and hypertext documents. Most online help systems, for example, are hierarchical. You start with a list or menu of major topics; selecting one leads you to a list of subtopics, which then leads you to discussion about a particular topic. Different help systems have different levels, of course, but most follow this simple structure.

In a hierarchical organization, it's easy for readers to know their position in the structure; choices are to move up for more general information or down for more specific information. Providing a link back to the top level enables your reader to get back to some known position quickly and easily. In hierarchies, the home page provides the most general overview to the content below it. The home page also defines the main links for the pages further down in the hierarchy.

If you selected Fruits, you would then be linked “down” to a page about fruits. From there you can go back to the home page, or you can select another link and go further down into more specific information about particular fruits.

Selecting Soft Fruits takes you to yet another menu-like page, where you have still more categories to choose from. From there you can go up to Fruits, back to the home page, or down to one of the choices in this menu.

Note that each level has a consistent interface (up, down, back to index), and that each level has a limited set of choices for basic navigation. Hierarchies are structured enough that the chance of getting lost is minimal (This is especially true if you provide clues about where “up” is; for example, a link that says “Up to Soft Fruits” as opposed to just “Up”). Additionally, if you organize each level of the hierarchy and avoid overlap between topics (and the content you have lends itself to a hierarchical organization), hierarchies can be an easy way to find particular bits of information. If that was one of your goals for your readers, using a hierarchy may work particularly well.

Avoid including too many levels and too many choices, however, because you can easily annoy your reader. Too many menu pages results in “voice-mail syndrome.” After having to choose from too many menus you forget what it was you originally wanted, and you're too annoyed to care. Try to keep your hierarchy two to three levels deep, combining information on the pages at the lowest levels (or endpoints) of the hierarchy if necessary. Linear

Another way to organize your documents is to use a linear or sequential organization, much like printed documents are organized. In a linear structure the home page is the title, or introduction, and each page follows sequentially from that structure. In a strict linear structure, there are links that move from one page to another, typically forward and back. You may also want to include a link to “Home” that takes you quickly back to the first page.

Context is generally easy to figure out in a linear structure simply because there are so few places to go. A linear organization is very rigid and limits your readers' freedom to explore and your freedom to present information. Linear structures are good for putting material online when the information also has a very linear structure offline (such as short stories, step-by-step instructions, or computer-based training), or when you explicitly want to prevent your reader from skipping around. For example, consider teaching someone how to make cheese using the Web. Cheese-making is a complex process that involves several steps that must be followed in a specific order.

Describing this process using Web pages lends itself to a linear structure rather well. When navigating a set of Web pages on this subject, you would start with the home page, which might have a summary or an overview of the steps to follow. Then, using the link for “forward,” move on to the first step, “Choosing the Right Milk”; to the next step, “Setting and Curdling the Milk”; all the way through to the last step, “Curing and Ripening the Cheese.” If you needed to review at any time, you could use the link for “back.” Since the process is so linear, there would be little need for links that branch off from the main stem or links that join together different steps in the process. Linear with Alternatives

You can soften the rigidity of a linear structure by allowing the reader to deviate from the main path. For example, you could have a linear structure with alternatives that branch out from a single point. The offshoots can then rejoin the main branch at some point further down, or they can continue down their separate tracks until they each come to an “end.”

For example, say you had an installation procedure for a software package that was similar in most ways, regardless of the computer type, except for one step. At that point in the linear installation, you could branch out to cover each system.

After the system-specific part of the installation, you could then link back to the original branch and continue on with the generic installation. In addition to branching from a linear structure, you could also provide links that allow readers to skip forward or back in the chain if they need to review a particular step or if they already understand some content.

Combination of Linear and Hierarchical

A popular form of document organization on the Web is a combination of a linear structure and a hierarchical one. This structure occurs most often when very structured but linear documents are put online; the popular FAQ (Frequently Asked Questions) files use this structure.

The combination of linear and hierarchical documents works well as long as there are appropriate clues regarding context. Because the reader can either move up and down or forward and back, it's easy to lose one's mental positioning in the hierarchy when one crosses hierarchical boundaries by moving forward or back. For example, say you were putting the Shakespearean play Macbeth online as a set of Web pages. In addition to the simple linear structure that the play provides, you could create a hierarchical table of contents and summary of each act linked to appropriate places within the text. Because this is both a linear and hierarchical structure, on each page of the script you provide links to go forward, back, return to beginning, and up. But what is the context for going up? If you've just come down into this page from an act summary, the context makes sense. “Up” means go back to the summary you just came from. But say you went down from a summary and then went forward, crossing an act boundary (say from Act 1 to Act 2). Now what does “up” mean? The fact that you're moving up to a page that you may not have seen before is disorienting given the nature of what you expect from a hierarchy. Up and down are supposed to be consistent. Consider two possible solutions:

Do not allow “forward” and “back” links across hierarchical boundaries. In this case, in order to read from Act 1 to Act 2 in Macbeth, you would have to move up in the hierarchy and then back down into Act 2.

Provide more context in the link text. Instead of just “Up” or an icon for the link that moves up in the hierarchy, include a description as to where you're moving.

Web

A web is a set of documents with little or no actual overall structure; the only thing tying each page together is a link. The reader drifts from document to document, following the links around.

Web structures tend to be free-flowing and allow the reader to wander aimlessly through the content. Web structures are excellent for content that is intended to be meandering or unrelated, or when you want to encourage browsing. The World Wide Web itself is, of course, a giant web structure. An example of content organized in a web structure might be a set of virtual “rooms” created using Web pages. If you've ever played an old text-adventure game like Zork or Dungeon, or if you've used a MUD (Multi-User Dungeon), you are familiar with this kind of environment. In the context of a Web presentation, the environment is organized so that each page is a specific location (and usually contains a description of that location). From that location you can “move” in several different directions, exploring the environment much in the way you would move from room to room in a building in the real world (and getting lost just as easily). From the home page you can then explore one of the links.

Each room has a set of links to each “adjacent” room in the environment. By following the links, you can explore the rooms in the environment. The problem with web organizations is that it's too easy to get lost in them—just as you might in the “world” you were exploring in the example. Without any overall structure to the content, it's difficult to figure out the relationship between where you are and where you're going, and, often, where you've been. Context is difficult, and often the only way to find your way back out of a Web structure is to retrace your steps. Web structures can be extremely disorienting and immensely frustrating if you have a specific goal in mind. To solve the problem of disorientation, you can use clues on each page. Two ideas:

Provide a way out. “Return to home page” is an excellent link.

Include a map of the overall structure on each page, with a “you are here” indication somewhere in the map. It doesn't have to be an actual visual map, but providing some sort of context will go a long way towards preventing your readers from getting lost.

3.1.5.3.7.4 Storyboarding Your Web Presentation

Storyboarding Your Web Presentation

The next step in planning your Web presentation is to figure out what content goes on what page and to come up with some simple links for navigation between those pages. Much of the organization may arise from the site navigation structure, in which case this task will be easy. If you want to combine different kinds of structures, however, or if you have a lot of content that needs to be linked together in sophisticated ways, sitting down and making a specific plan of what goes where will be incredibly useful later on as you develop and link each individual page.

Storyboarding a presentation is a concept borrowed from filmmaking in which each scene and each individual camera shot is sketched and roughed out in the order in which it occurs in the movie. Storyboarding provides an overall structure and plan to the film that allows the director and his staff to have a distinct idea of where each individual shot fits into the overall movie.

The storyboard provides an overall rough outline of what the presentation will look like when it's done, including which topics go on which pages, the primary links, maybe even some conceptual idea of what sort of graphics you'll be using and where they will go. With that representation in hand, you can develop each page without trying to remember exactly where that page fits into the overall presentation and its often complex relationships to other pages.

Storyboarding, borrwed from filmmaking, is the process of creating a rough outline and sketch of what your presentation will look like before you actually write any pages. Storyboarding helps you visualize the entire presentation and how it will look when it's complete.

In the case of really large sets of documents, a storyboard enables different people to develop different portions of the same Web presentation. With a clear storyboard, you can minimize duplication of work and reduce the amount of contextual information each person needs to remember. For smaller or simpler Web presentations, or presentations with a simple logical structure, storyboarding may be unnecessary. But for larger and more complex projects, the existence of a storyboard can save enormous amounts of time and frustration. If you can't keep all the parts of your content and their relationships in your head, consider doing a storyboard. So what does a storyboard for a Web presentation look like? It can be as simple as a couple of sheets of paper. Each sheet can represent a page, with a list of topics that each page will describe and some thoughts about the links that page will include. I've seen storyboards for very complex hypertext systems that involved a really large bulletin board, index cards, and string. Each index card had a topic written on it, and the links were represented by string tied on pins from card to card.

The point of a storyboard is that it organizes your Web pages in a way that works for you. If you like index cards and string, work with it. If a simple outline on paper or on the computer works better, use that instead.

Hints for Storyboarding

Some things to think about when developing your storyboard are as follows:

Which topics will go on each page?

A simple rule of thumb is to have each topic represented by a single page. But if you have a large number of topics, maintaining and linking them can be a daunting task. Consider combining smaller, related topics onto a single page instead. However, don't go overboard and put everything on one page; your reader still has to download your document over the Net. It's better to have several medium-sized pages (say, the size of two to 10 pages in your word processor) than to have one monolithic page or hundreds of little tiny pages.

What are the primary forms of navigation between pages?

What links will you need for your reader to navigate from page to page? These are the main links in your document that enable your reader to accomplish the goals you defined in the first section. Links for forward, back, up, down, or home all fall under the category of primary navigation.

What alternative forms of navigation are you going to provide?

In addition to the simple navigation links, some Web presentations contain extra information that is parallel to the main Web content, such as a glossary of terms, an alphabetical index of concepts, or a credits page. Consider these extra forms of information when designing your plan, and think about how you are going to link them into the main content.

What will you put on your home page?

Since the home page is the starting point for the rest of the information in your presentation, consider what sort of information you're going to put on the home page. A general summary of what's to come? A list of links to other topics?

Review your goals.

As you design the framework for your Web presentation, keep your goals in mind, and make sure you are not obscuring your goals with extra information or content.

3.1.5.3.7.5 State Value Points by Customer by Page

3.1.5.3.7.6 State Value Points by Topic by Customer

3.1.5.3.7.7 Specify Business and Site Participants

Specify all types of users and their activities. Classify who each type of user is and what they can do in the system.

3.1.5.4 State Need for Staffing

3.1.5.5 State Need for Full Time Employee

3.1.5.6 State Need for Surge Effort

3.1.5.7 State Specific Need in Staffing for Full Time Employees

3.1.5.8 State Specific Need for Performance of Project (RFP)

3.1.5.9 State Specific Need for Staffing for Surge (Body Shop)

3.1.5.10 State Specific Need for Task Completions for Surge

3.1.5.11 Enter Incubator

3.1.5.12 Determine Response to RFP

3.1.5.13 Recast RFP Project as E-Effort

3.1.5.14 Propose Job Opportunity Recruitment Effort

3.1.5.15 Propose Effort Opportunity (Project/Task Oriented) (E-Effort)

3.1.5.16 Negotiate Effort Deals

3.1.5.17 Negotiate Recruiter Deals

3.1.5.18 Publish Results of Tasks to Customers for Acceptance Review

3.1.5.19 Publish Results of Tasks to Prospective Customers for Sales Purposes

3.1.5.20 Approve/Accept Project Deliverables

3.1.5.21 Approve/Accept Surge Task Progress/Deliverables

3.1.5.22 Customer Monitors Project Progress

3.1.5.23 Customer Monitors Surge Task Progress

3.1.5.24 Obtain Maintenance for Completed Websites

3.1.5.25 Maintain Completed Sites

3.1.5.26 Provide Billing To Customers for Effort, Track Receivables

3.1.5.27 Maintain a Record of Customer Satisfaction

3.1.5.28 Obtain Referrals from Customers for New Efforts

3.1.5.29 Learn of Incubator Program

3.1.5.30 Negotiate Deal for Entering Incubator

3.1.5.31 E-Effort Marketing and Sales

E-Effort Networks, Inc. management will solicit clients and draft contracts for work with existing companies for cash and with startups for a cash-equity mix. Projects are expected to be surge work and web development for existing businesses, and web development for startups.

3.1.5.32 Web Business Management

3.1.5.33 Approve Copy and Image

3.1.5.34 Approve Page

3.1.5.35 Collect Customer Information

3.1.5.36 Define Affiliate

3.1.5.37 Client Binder

DAOU-Sentient's Client Binder is a groupware application used to manage client and project information. The application acts as a repository for client, contract, and project information, and is used by all employees during their day-to-day tasks.

Built on the Lotus Notes platform, this application allows messaging, security of documents, remote access through the web, and remote access and replication to remote employees. It is a series of forms that are linked to each other, so that changes on one document can be rolled to other documents as needed.

3.1.5.37.1 Client Data Sheet

At the top of the Client Data Binder hierarchy of documents is the Client Data Sheet. This is the highest-level document in the database and provides a primary identification and category.

Predominant use of the Client Data Sheet is to create primary identification, and to store primary administrative categories. This information is used for internal operational reports, and accounting reports for billing and sales commission.

After some basic accounting information that notes creation and edit information, there is a list of demographic information for this “client”. This is a name for this client, primary address, and telephone number. The creation of this is by convention—a client could be a business subsidiary, or even an internal department. DAOU-Sentient tends to use these as “contracting entities”, to help break out the contract data level below the client data level. For example, if there are two business units for a client with different contracting requirements, we might define them as two “clients”, regardless of the relationship between the business units. At the same time, we might define a non-client, like “sales support”, to segregate the activity in this area for tracking purposes.

After demographic information, there is an “alert” element. This allows the database to automatically send reminders to people based on some timed interval. Typically, it is to remind management and sales that a contract is up for renewal. In reality, it could be used for any workgroup trigger.

A description field is placed next, to allow documentation of the client, their business, and possibly our objectives with them. With corporate web pages providing so much of this content at this point, this area can be a simple list of links to other areas. There is also an area for Dunn & Bradstreet information, to provide a repository for this information.

Finally, there are a number of accounting related fields that help with reports and administrative tracking. Account Manager assigns the primary sales relationship responsibility, and is controlled from the Notes address book. Territory helps break out work by geographical territory, and is a radio style button. DAOU-Sentient has sales territories across the country, and there is a “national” account territory that overlaps the sales territories. Status identifies the client as a prospect, client, former client, shared client (with other DAOU business units), or vendor.

The last few fields provide additional accounting detail for billing and long distance charge tracking.

3.1.5.38 Incubator Company Contracting

Confidentiality/Protection (Non-disclosure) of Ideas

Expectations

Milestones

Milestone projections/expectations/benchmarks & the embedding of control mechanisms (when do we start/estimated completion date of site)

Measurement of the control mechanisms

Assignment of responsibilities & what's expected of each party involved

Accountability

Equity Ownership of Companies/Logistics of Intertwinement

Ownership of Site (during and after completion)

Ownership of Development Tools

Establishment of Any New Entity (Timing, Including Approval Process)

Kick-out Clause

3.1.5.39 Surge Effort Contracting

3.1.5.40 Determine Incubator Company Ownership Proportion

3.1.5.41 State general Need for Completions in Document of Understanding

3.1.6 E-EFFORT EXTERNAL ACTIVITIES

3.1.6.1 Connect Full Time Employee w Employer

3.1.6.2 Track Recruitment Activity

3.1.7 Organizational Management

3.1.7.1 Sales and Business Development

Incubator Marketing/Public Relations

Deal Recruitment and Services Sales

Deal Evaluation

Deal-Making Methodology Management

3.1.7.1.1 Incubator Marketing

3.1.7.1.2 Deal Recruitment and Services Sales

3.1.7.1.3 Deal Evaluation

3.1.7.1.4 Deal-Making Methodology Management

3.1.7.2 Mentoring for Success

Mentoring for Success (for Incubated Company)

Corporate Planning

Marketing Approach Refinement

Team Development

Deliverables

Strategy Phase

Strategy and Potential Strategic Relationships

Business Plan Outline

Analysis Phase

Objectives

Financial Plans/Projections/Equity

Marketing & Sales/Site Promotion

Infrastructure for Control/Accounting

Goal: Team Job Descriptions

3.1.7.3 Project Management and Technical Development

Incubator Technical

Project Management

Development Methodology Management

Technical contributors (programmers)

Systems Maintenance

Graphics

Database Administration

Site Development Management

Site Refinement Management

Site Maintenance Management

Infrastructure Management

Common Software Reuse

Backend Reuse

Tool Adaptation & Management; Maintenance

Deal Impact Analysis

Score Card Review

Deliverables

Description of Result Contents

Contact Information

Status Information

Issues/Problems List

Limitations List

New Information regarding task

Descriptions, with:

Context

Contact Information

Work Breakdowns

Due Dates

Priorities

Point Estimates

Populated ‘Notes’ for Sutask Packages Infrastructure Plans

3.1.7.4 Harvesting

Value Event Management

Potential Value Event List

Posture Descriptions

Posture Management

Audit & Control for Operations

Site Effectiveness Audits

Marketing & Management Reviews

Dealmaking for Restructuring Deals

Score Card Control

3.1.7.5 Triage

Extrication from Involvement on Deals

Salvage of Site/Software Rights

Salvage of Relationships

Renegotiations

Plans & Methodology Capture

Leaving& Dealmaking Improvements

Score Card Review

3.1.7.6 Resource Recruitment/Human Resources

3.1.7.7 Incubator Management

3.1.7.8 Control and Finance

3.1.8 Task Control

3.1.8.1 Breakdown Tasks for Effort—E-Effort

Descriptions, with:

Context

Contact Information

Work Breakdowns

Due Dates

Priorities

Point Estimates

Populated ‘Notes’ for Subtask Packages Infrastructure Plans

3.1.8.2 Estimate Task Effort by Breakdown

3.1.8.3 Issue Tracking

Issue Tracking

3.1.8.4 Note Entry

Enter a free text note.

3.1.8.5 Project Look Up

Project Look Up

3.1.8.6 Task Tracking

3.1.9 Infrastructure Management for E-Effort

3.1.9.1 Back Office Services and Systems

3.1.9.2 Office Space Management

3.1.9.3 Web and Applications Hosting

3.1.9.4 Database Hosting

4 Objectives

5 Critical Success Factors

6 Priorities

7 Deficiencies Being Overcome

9 Assumptions Made

10 Open Fact Finding Questions

11 Other Open Issues

12 Locations Involved

7 Glossary

7.1 Associate or Contributor

A contributor is a worker that is a member of e-effort and provides work toward an e-effort job. A person who performs tasks within the e-Effort framework.

7.2 Business Intelligence

Business Intelligence—a system to track, measure, analyze and report on activities in your Web business

7.3 Business-to-Business E-Commerce Models

business-to-business e-commerce websites link buyers, suppliers, and intermediaries together in any of the following models: (1) the catalog model (through the building of customer storefronts), (2) the auction model, (3) a reverse auction model, (4) an aggregated buyers' group model, (5) the exchange model, (6) a classified section model

7.4 Catalog Storefronts

catalog storefronts a place where manufacturers, distributors, and service companies can display their product lines, service offerings, and other business information such as company contact information; telephone, fax, and email; description of company; web site address; methods of distribution; sales area; ownership type; date business established; annual sales and fiscal year; total number of employees; number of salespeople, etc.

7.5 Certification

Vendor-Specific Programs

Most certification programs are built by vendors for their specific products and programs. This gives them a great way to flog their products and to explain their capabilities in great detail. In fact, most vendor certifications cover their subject matter very well. But alas, many of them don't acknowledge defects in products and technologies.

Likewise, to promote good PR and to stimulate sales, vendor programs can't be as candid about problems that users or technicians are likely to encounter with their products and program. Nor do they typically expose the various known “gotchas” that working experts must learn to overcome when they dig deeply into such environments. This lack of ultimate truth is a sad way of life for vendor certs. You have to expect a certain lack of candor if you're going to walk hand-in-hand with a vendor toward that vendor's certification.

Sun Certified Java Programmer http://www.sun.com/service/suned

Sun offers certification Solaris and the Sun OS, but Sun also offers certs for users of its trendy Java programming language. Today, this environment incorporates related technologies like Java Beans, JDBC and Java Servlets. Java is so popular today that companies like IBM, Novell, and Netscape assembled to accept Sun's own entry-level Java certification—the Certified Java Programmer—as THE entry-level certification for their Web developer programs and other related certifications.

Although Java certification is not exactly vendor-neutral, multi-vendor support makes the Certified Java Programmer title valuable. The Certified Java Programmer exam costs $150 and comes in three versions, for each Java Development Kit currently available.

Oracle Database Certifications http://education.oracle.com/certification

Because Oracle databases are popular, and its certified population is still pretty small, anybody who's interested in

7.6 Content

What Do You Want To Do on the Web?

This may seem like a silly question. You wouldn't have bought this book if you didn't have some idea of what you want to put online already. But maybe you don't really know what it is you want to put up on the Web, or you have a vague idea but nothing concrete. Maybe it has suddenly become your job to put your company on the Web, and someone handed you this book and said “Here, this will help.” Maybe you just want to do something similar to some other Web page you've seen that you thought was particularly cool. What you want to put on the Web is what I'll refer to throughout this book as your content. Content is a general term that can refer to text, or graphics, or media, or interactive forms, or anything. If you were to tell someone what your Web pages are “about,” you would be describing your content.

Your content is the stuff you're putting on the Web. Information, fiction, images, art, programs, humor, diagrams, games—all of this is content.

What sort of content can you put on the Web? Just about anything you want to. Here are some of the kinds of content that are popular on the Web right now:

Personal information. You can create pages describing everything anyone could ever want to know about you and how incredibly marvelous you are—your hobbies, your resumé, your picture, things you've done.

Hobbies or special interests. A Web page could contain information about a particular topic, hobby, or something you're interested in, for example, music, Star Trek, motorcycles, cult movies, hallucinogenic mushrooms, antique ink bottles, or upcoming jazz concerts in your city.

Publications. Newspapers, magazines, and other publications lend themselves particularly well to the Web, and they have the advantage of being more immediate and easier to update than their print counterparts.

Company profiles. You could offer information about what a c

7.7 Content Management

Content Management—a system for designing the content, logic, presentation and delivery of a Web site, and to empower developers to easily control and access diverse types of content and commerce assets.

At the core of any large-scale Web business is a system for managing content and commerce assets. This encompasses:

the storage and delivery environment for content assets

an overall approach to the design and layout of a site

model for indexing and searching content

a method for profiling content and end users

Content Manager Database The content manager provides a content storage model. This enables developers to transparently store all forms of content in a structured object storage system. The content manager database is built on top of a standard relational database model, enabling customers to use almost any standard relational database as the actual storage infrastructure. Storing content in a core repository meets the key design goal of a clean separation of data or content from presentation. This allows developers to easily repurpose content based on a given user's browser, or for delivery using other formats, such as XML, RTF, e-mail, etc.

In addition, by storing content and commerce assets in the content manager database, it becomes easier to archive and maintain versions of content used on a Web site. Rather than having to manually remove links or replace files in directories, business managers can directly flag items to be deactivated, making them unavailable to be published, or archived.

Using the COAPI shields developers from having to program or manipulate the XML content, instead they use a simple tag-based API to interact with the content manager database. Because the COAPI is extensible to support any form of backend system, developers can simultaneously access content stored in either the content manager database or in their own external databases.

7.8 Content Object API

ContentObject API, or COAPI. The COAPI enables companies to model their Web systems using an object-based programming and information management approach. All key services provided by Allaire Spectra leverage the COAPI, and therefore all applications and sites built on the COAPI can easily leverage these additional services.

The COAPI is the low-level programming model that supports large-scale Web systems. At the lowest levels, the COAPI binds together the services and system pieces in a manner that reflects the needs of each level of user.

7.9 Home Page

The terms Web presentation, site, and page are pretty easy to grasp, but the term “home page” is a little more problematic because it can have several different meanings.

If you are reading and browsing the Web, the home page is usually referred to as the Web page that loads when you start up your browser or when you choose the “Home” button. Each browser has its own default home page, which is often the same page for the site that developed the browser. (For example, the Netscape home page is at Netscape's Web site, and the Lynx home page is at the University of Kansas.)

Within your browser, you can change that default home page to start up any page you want—a common tactic I've seen many people use to create a simple page of links to other interesting places or pages that they visit a lot.

If you're publishing pages on the Web, however, the term home page has an entirely different meaning. The home page is the first or topmost page in your Web presentation—it's the entry point to the rest of the pages you've created and the first page your readers will see.

The home page usually contains an overview of the content in the presentation available from that starting point—for example, in the form of a table of contents or a set of icons. If your content is small enough, you may include everything on that single home page—making your home page and your Web presentation the same thing.

The home page is the entry or starting point for the rest of your Web presentation.

7.10 Membership Database

Membership databases are technically no different than other user directories. Their security policies are defined and applied in exactly the same manner as for back-office users. However, they are crucially different in terms of how companies store and manage this information. Unlike user directories for internal management functions (such as NT Domains and LDAP directories), membership databases often already exist in the form of customer accounts and customer databases.

7.11 Personalization

Personalization—a system for dynamically profiling and targeting information to end users based on their interests and behavior

7.12 Process Logic

While workflow services are designed for multi-person, concurrent processes, process logic paths or PLPs, are designed to handle the management and execution of linear or serial processes, and for processes that require maintaining the state of transactions, such as online registration systems, wizards, and order processing engines. PLPs are typically used for single-person, end user applications.

Interactive developers and business managers collaborate to define common end user processes, such as registering for a Web site, submitting an online customer service request, or purchasing a product through an online store. PLPs allow these users to define complex, nested tree-structures, and to arrange steps in a process visually, without changing code.

For instance, a PLP could be defined for purchasing products through an online store. Once an end user selects a product or set of products through the online store, a PLP is started to process the order. The first step checks if the user already has an account, and if so, simply executes the order using one-click ordering. If the user does not have an account, it spawns another PLP for registering the end user with the site. Once the end user has completed their registration PLP, they are returned to the order processing PLP. The next steps check inventory, process the credit card, and initiate a shipping method. Depending on the payment method selected, another sub-PLP could be invoked to collect additional end user information. A confirmation screen would end the PLP, with the final step both sending an email notification to the end user confirming their order, and starting up a new workflow instance for internally managing the incoming order.

PLPs also provide a set of tools for managing error conditions and exceptions, allowing interactive developers to define how a PLP should rollback to earlier steps in a process. Additionally, PLPs automa

7.13 Relelvant Access Tool

The goal of the Content Manager database is to empower developers to easily control and access diverse types of content and commerce assets. The goal of the Relevant Access Tool is to empower business users and business managers to actively and easily manage the assets and business processes of the Web business. Relevant Access empowers business users to directly create and manage content in the Web site without intervention or involvement from IT or HTML developers. This is accomplished through the ability of business users to directly activate content for changes and additions directly from within the site beign developed itself. This in-context editing model provides users with a set of UI controls directly in a site's pages. For instance, if marketing users owned the news section of an enterprise portal, they would simply navigate through the site to the page where they owned content. The page would know this user has the authority to perform changes, and would offer the user a set of UI controls to perform their work.

7.14 Role-Based Security

Role-Based Security—a system for securing the production, management and delivery of your Web application

As the Web becomes the central computing platform for running a business, the role of security and access control becomes central to how companies will scale to enterprise-wide adoption of the Web. A very rich and extensible set of role-based security services are needed in a large website. The broad goals of role-based security is to simultaneously empower all participants in the Web business to execute their work with ease, and at the same time to give IT and business managers tight control over how users interact with the system, ensuring accountability and manageability over this emerging critical infrastructure.

A common security model across all types of users and activities simplifies this task. Each type of user participates in a security realm, which classifies who they are and what they can do in the system.

Within each security realm user authentication information from a user directory, combined with user activity plans are combined to create policies that govern what activities a user is allowed to perform on the site.

This common security model provides a simple, coherent and reusable method for applying security through out your Web infrastructure.

7.15 Security Realm

A common security model across all types of users and activities. A security realm classifies who each type of user is and what they can do in the system. The primary security realms map to the spectrum of participants: system administrators, interactive developers, site designers, business users, business managers, site members, and site affiliates.

7.16 Shopping Cart Technology

Shopping Cart Technology browse product and service offerings and purchase medical supplies, equipment, and/or services

7.17 Site Affiliates

Based on new models of Internet business centered around affiliate and syndicate networks, site affiliates are your Internet business partners. Site affiliates are other Web sites, which may be supply-chain partners, or Web sites who resell and reuse your content and commerce assets. They could also be other Web sites whose assets you incorporate into your own Web systems. Site affiliates interact with your Web systems either programmatically through an API exposed by your site object model, or through the Webtop, where they act as business users defining content they want to syndicate from your systems.

7.18 Site Layout Model

The site layout model describes the site's navigation, branding, and look and feel. The site layout begins with an overall navigation structure for a site by defining the overall site structure, including site sections and pages. It also provides a means for control over access and security, site and page-wide logging and caching behavior.

7.19 Site Members

Site members are the end users of a website. A site member could be an internal employee accessing information and applications on an intranet, a supplier or partner using a secure extranet, or a customer accessing your Internet site. Site members are the ultimate customer for web applications, and through personalization services, are offered an extremely rich experience that can be managed over the lifecycle of their interactions with your business.

7.20 Site Metadata

Site Content Metadata (Site Categories)

A key component of a broad content management solution is the strategic use of metadata, or what we call site categories. Metadata is used to tag, or mark content items with data that identifies the types of content in use. Metadata provides the foundation for a range of other capabilities, including higher level end user browsing and searching tools, user interest profiling, and rich reporting on which classes of content and products are most popular in a Web site.

Site category Metadata allow developers and business users to define categories and keywords that any piece of content can inherit. For instance, for a sports portal, a set of common categories that content can inherit include sport, league, team, player and writer. Any given piece of content in the portal could be about one or more sports, leagues, teams or players, and each item would typically have a writer or author.

When business users add new content items to the system, they apply site category metadata information to the items. Once this is done, it becomes easier for end users to find information of interest to them. For instance, an end user of the portal can request all items about a given sports team, or all articles about a given league written by a given author. Likewise, because every piece of content that an end user views is tracked, it becomes easier to create a specific profile of that user. Using this profile, we can personalize content and product information shown to end users based on custom rules defined by interactive developers and business managers.

7.21 Site Navigation Concepts

Ideas for Organization and Navigation

At this point you should have a good idea about what you want to talk about and a list of topics. The next step is to actually start structuring the information you have into a set of Web pages. But before you do that, consider some “standard” structures that have been used in other help systems and online tools. This section describes some of those structures, their various features, and some important considerations, including

The kinds of information that work well for each structure

How readers find their way through the content of each structure type to find what they need

How to make sure readers can figure out where they are within your documents (context) and find their way back to a known position

Think, as you read this section, how your information might fit into one of these structures or how you could combine these structures to create a new structure for your Web presentation.

Many of the ideas in this section were drawn from a book called Designing and Writing Online Documentation by William K. Horton (John Wiley & Sons, 1994). Although Horton's book was written primarily for technical writers and developers working specifically with online help systems, it's a great book for ideas on structuring documents and for dealing with hypertext information in general. If you start doing a lot of work with the Web, you might want to pick up this book; it provides a lot of insight.

Hierarchies

Probably the easiest and most logical way to structure your Web documents is in a hierarchical or menu fashion. Hierarchies and menus lend themselves especially well to online and hypertext documents. Most online help systems, for example, are hierarchical. You start with a list or menu of major topics; selecting one leads you to a list of subtopics, which then leads you to discussion about a particular topic. Different help systems have di

7.22 Site Object Model

The set of components that model the information and processes used to run the Web business.

A site object model is a collection of ContentObject Types. Each object type contains a set of properties and methods. Properties are the elements of data associated with an object type. For instance, a product object type might have SKU, Name, Price and Category as properties. Methods are the activities that surround the object, such as create, display and order. The code that manages the activities is built using ColdFusion. The proper ties of information or data can be stored and managed by the content manager, using the ContentObject database, or in any external RDBMS accessed via SQL or object middleware.

7.23 Site Object-Based Programming Model

Site object-based programming model for constructing Web systems. Interactive developers, business managers and site designers collaborate to define the overall information architecture for the Web systems. From this collaboration emerges a set of components that model the information and processes used to run the Web business. This is called the site object model. The site object model is a blueprint for the Internet business. Not only is it literally the underlying glue that ties together information—how it is managed and deployed—but is also the foundation for layering richer forms of capabilities on top of it, such as workflow, roles-based security and syndication.

7.24 Spectrum of Participants

A Spectrum of Participants is a model for understanding how enterprises will scale their adoption of the Web across their organizations and out to their partners and customers. The spectrum of participants represents a best-practices based view into the roles and services needed by every class of user in your business.

7.25 Storyboarding

What Is Storyboarding and Why Do I Need It?

Storyboarding a presentation is a concept borrowed from filmaking in which each scene and each individual camera shot is sketched and roughed out in the order in which it occurs in the movie.

Storyboarding provides an overall structure and plan to the film that allows the director and his staff to have a distinct idea of where each individual shot fits into the overall movie. The storyboarding concept works quite well for developing Web pages as well. The storyboard provides an overall rough outline of what the presentation will look like when it's done, including which topics go on which pages, the primary links, maybe even some conceptual idea of what sort of graphics you'll be using and where they will go. With that representation in hand, you can develop each page without trying to remember exactly where that page fits into the overall presentation and its often complex relationships to other pages.

Storyboarding, borrwed from filmmaking, is the process of creating a rough outline and sketch of what your presentation will look like before you actually write any pages. Storyboarding helps you visualize the entire presentation and how it will look when it's complete.

In the case of really large sets of documents, a storyboard enables different people to develop different portions of the same Web presentation. With a clear storyboard, you can minimize duplication of work and reduce the amount of contextual information each person needs to remember. For smaller or simpler Web presentations, or presentations with a simple logical structure, storyboarding may be unnecessary. But for larger and more complex projects, the existence of a storyboard can save enormous amounts of time and frustration. If you can't keep all the parts of your content and their relationships in your head, consider doing a storyboard. So what does a storyboard for a Web pre

7.26 Syndication

Syndication—a system for extending your Web business to Internet business partners and other Web sites Syndication As corporations have invested in the Web over the past few years, they've quickly learned that one of the biggest assets of the Web are the other Web sites and companies on the Web. Corporations are beginning to understand that Internet-centric business requires building business models centered around relationships established between Web sites. Syndication services focus on enabling business models that leverage site-to-site relationships to drive business. Whether for an extranet-based supply-chain integration application, or an online e-commerce affiliate network, Syndication forms the backbone of rich content and enterprise application integration efforts.

Site Affiliates Just as your Web systems have standard end users or site members, in the age of syndication, your Web systems have site affiliates. Site affiliates are just another class of end user of your system. Site affiliates are assigned a default member group.

Site affiliates are your Internet-based business partners. These could be explicit sales and supplier partners for your existing business, or new partners forged through the Web, supplying you with Web content or leveraging the content and transactions on your site. Each site affiliate receives a unique username and password, which then allows either an individual or a remote program to request or submit information to and from your Web systems.

Application Syndication Once you've identified your site affiliates, the next step is to expose to them the specific information and applications required for your syndication relationship. Remote site automation allows you to expose elements of your site object model to site affiliates.

For instance, you may have a product catalog in your site object model. This product catalog allows for browsing and searc

7.27 Transactive Content

Transactive content is the idea that the successful use of the Web in a business requires a rich combination of content, commerce and customer interaction management. Transactive content systems are systems that have been built around the tight relationship between the content assets you manage, the services which enable commerce, and the ability to provide this to a customer in a rich, personalized manner. Transactive content systems implement best-practices in running a successful Internet business.

7.28 Web Page

A Web page is an individual element of a presentation in the same way that a page is a single element of a book or a newspaper (although, unlike a paper page, Web pages can be of any length). Web pages are sometimes called Web documents. Both terms refer to the same thing: a Web page is a single disk file with a single filename that is retrieved from a server and formatted by a Web browser.

A Web page is a single element of a Web presentation and is contained in a single disk file.

7.29 Web Presentation

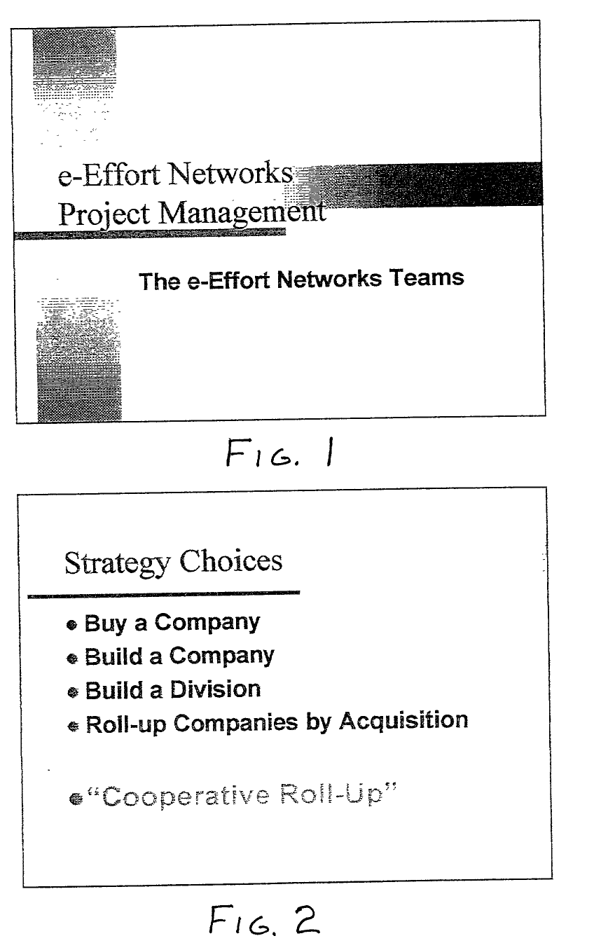

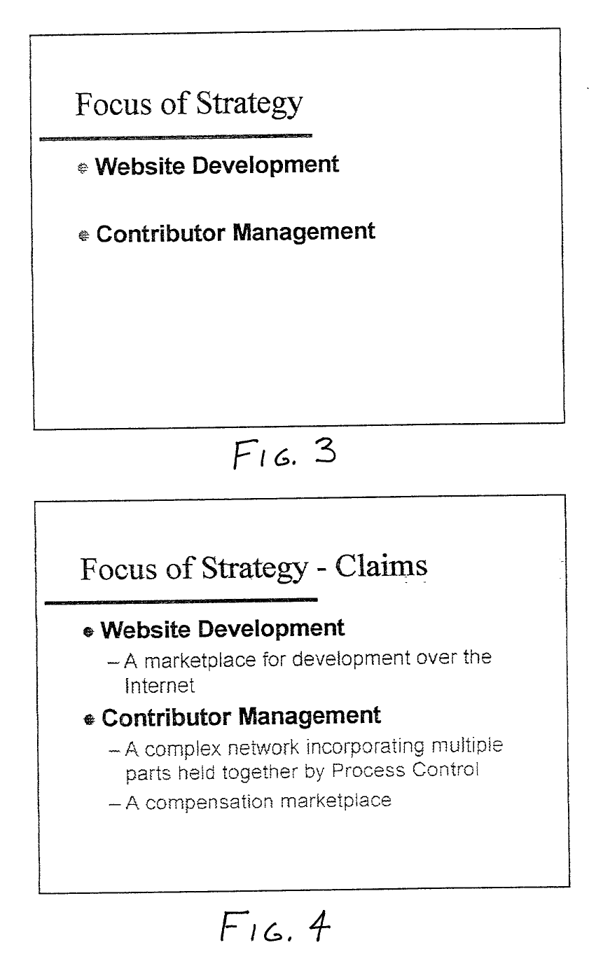

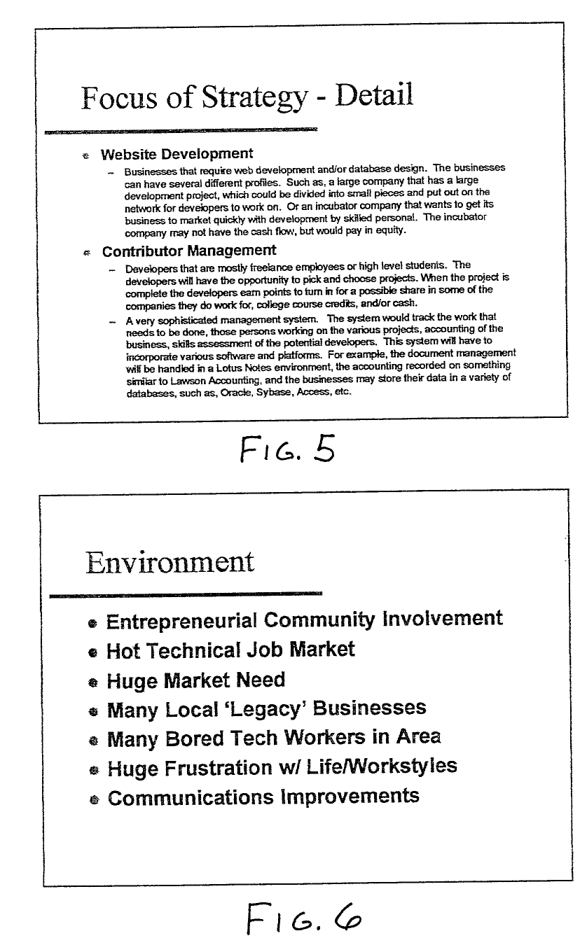

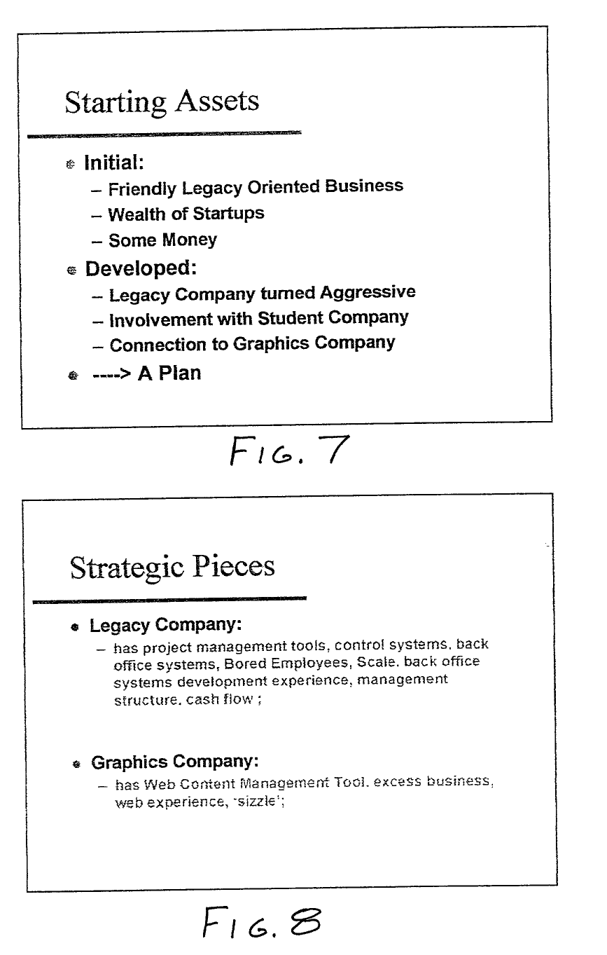

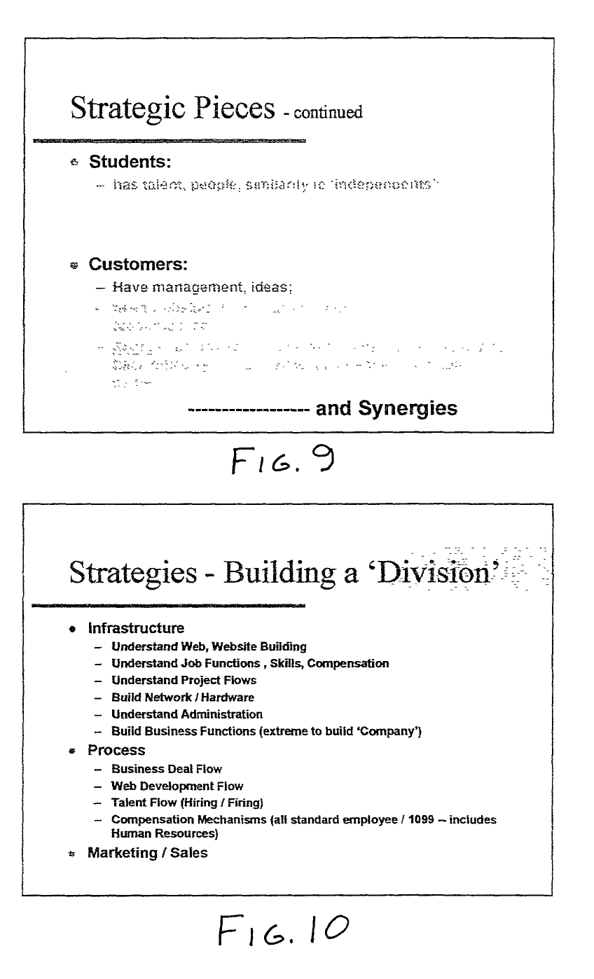

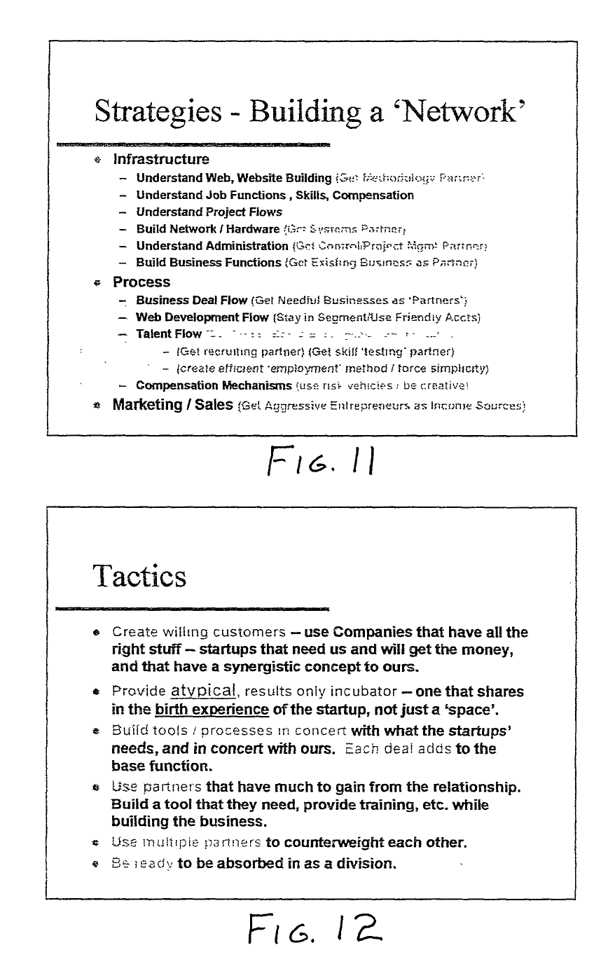

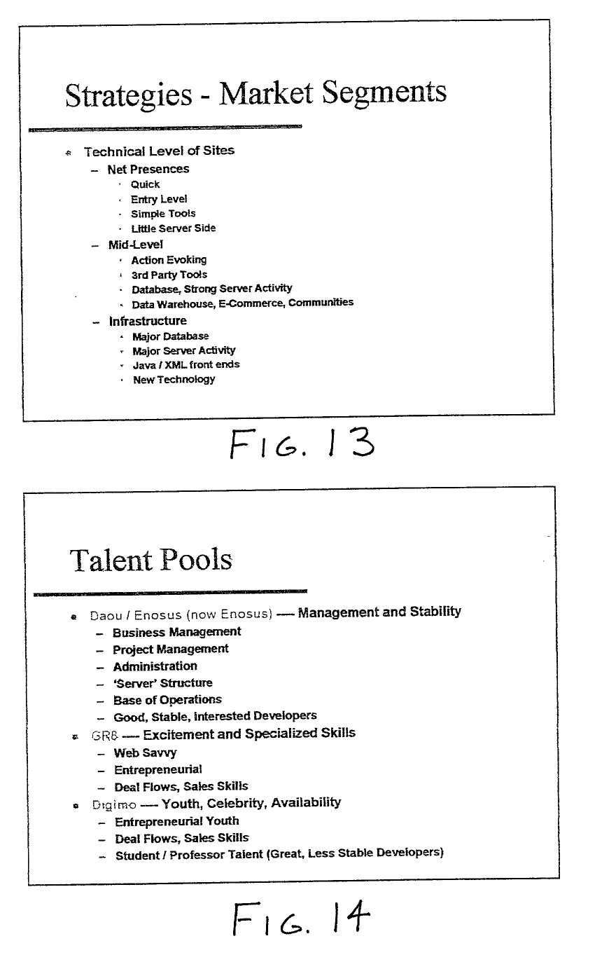

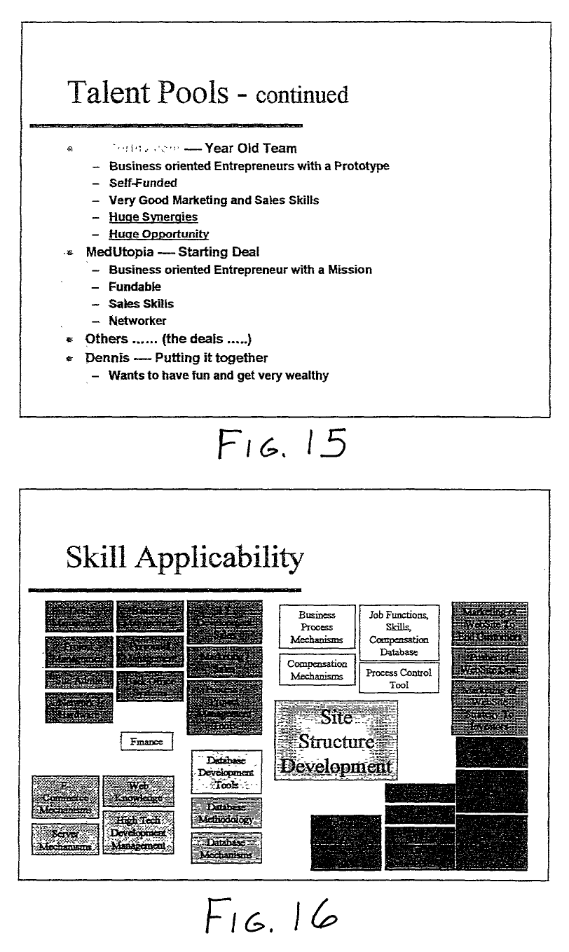

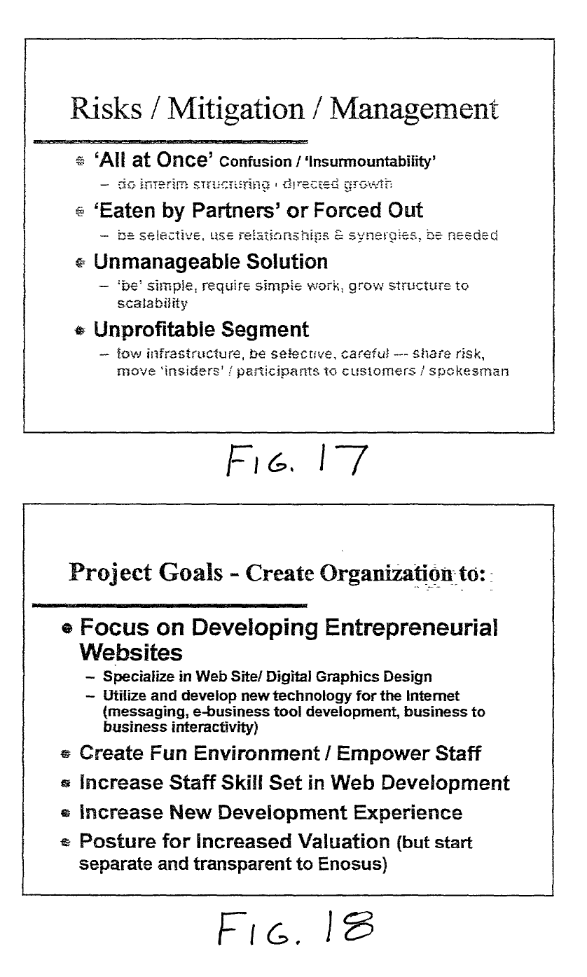

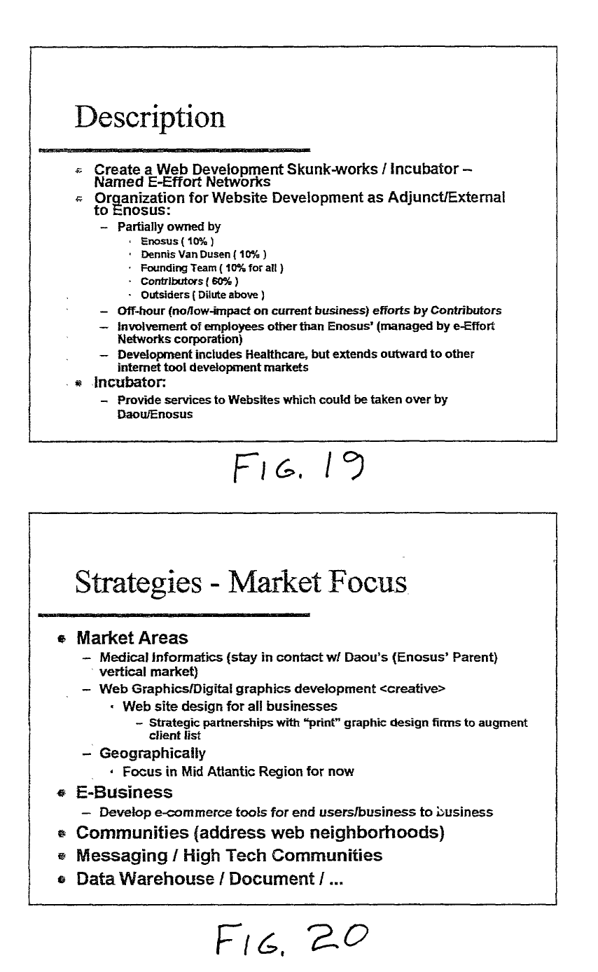

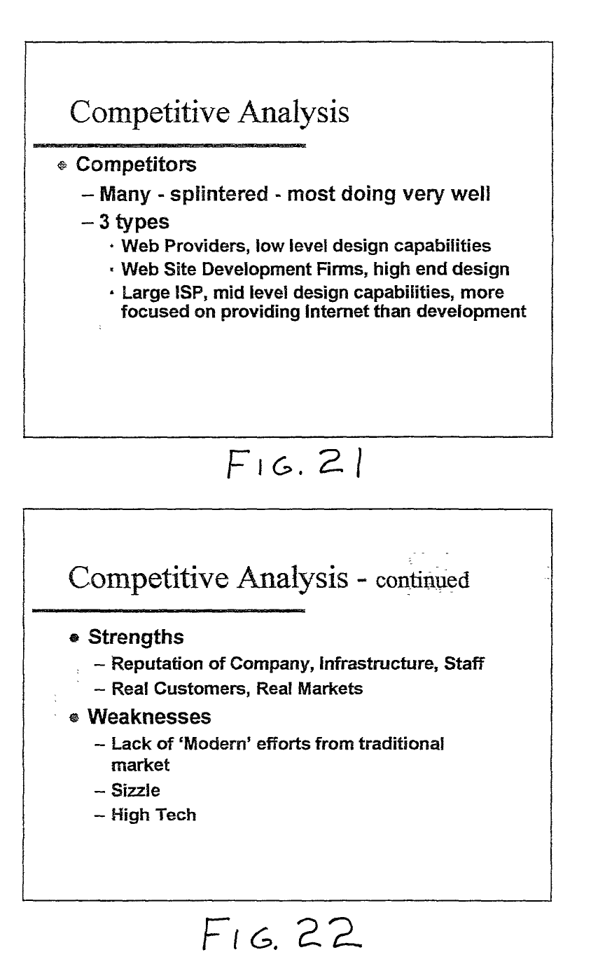

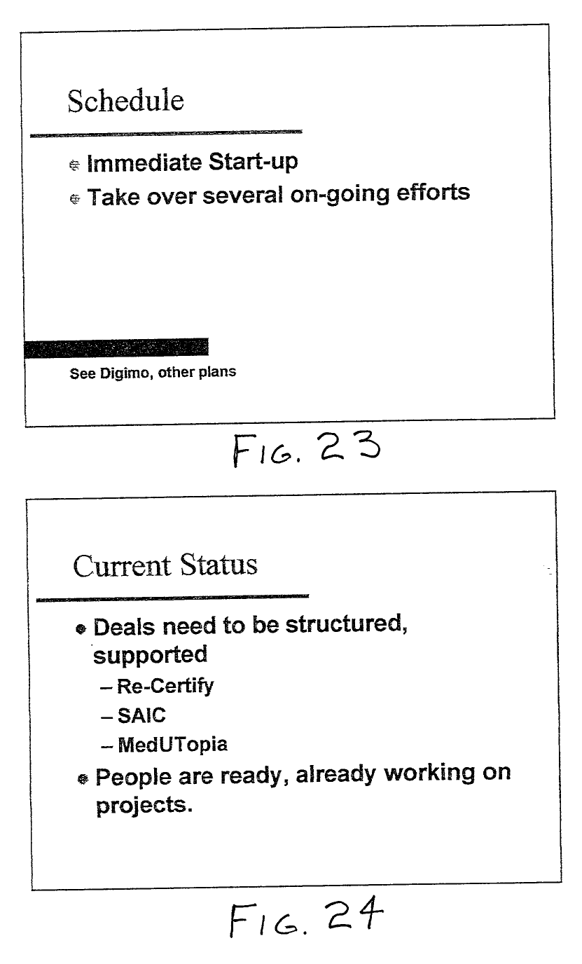

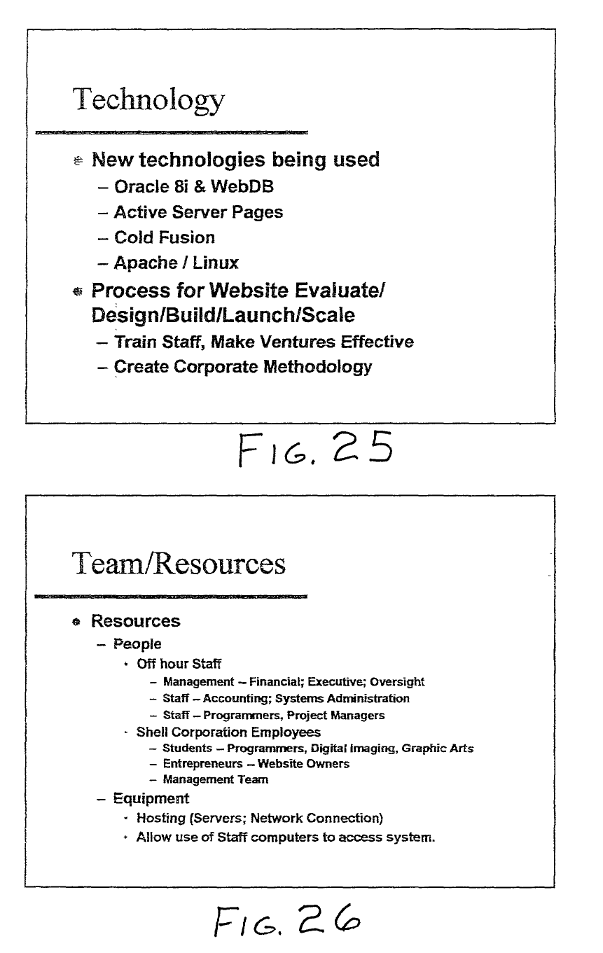

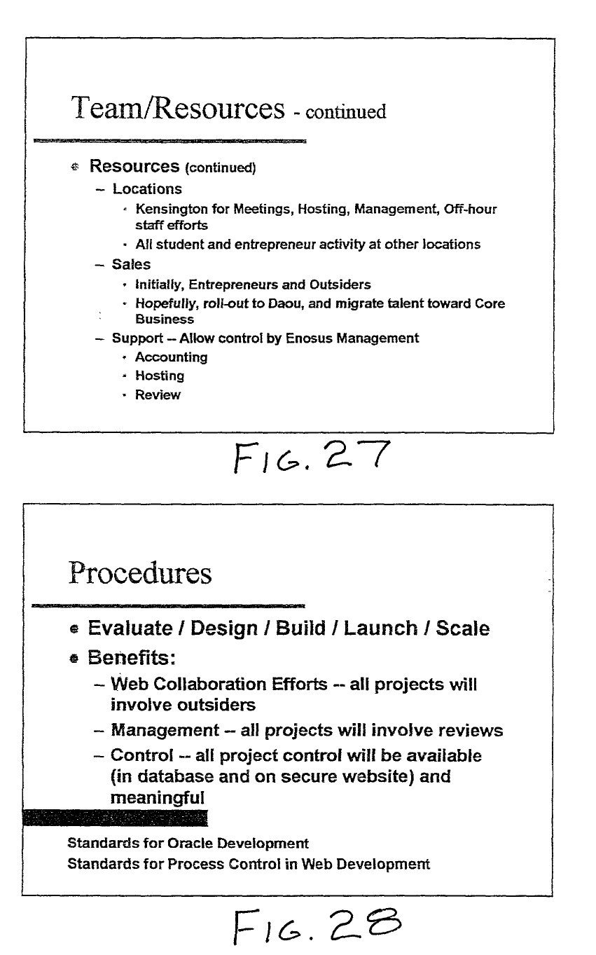

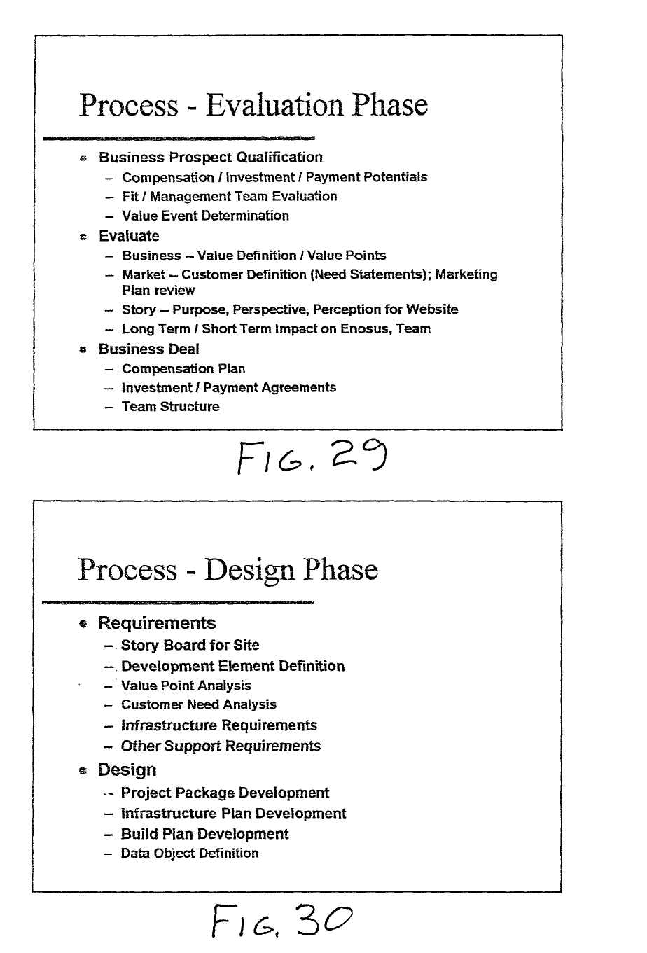

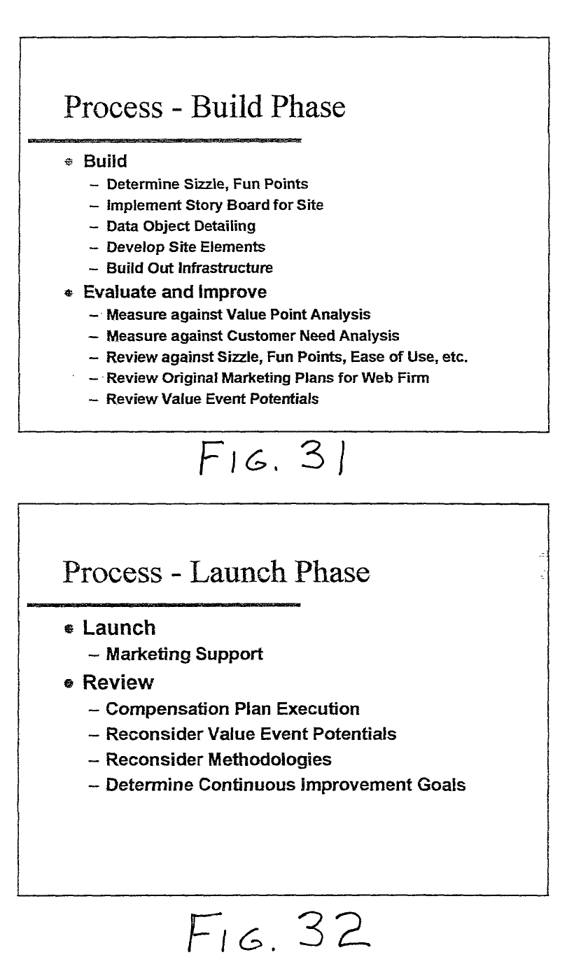

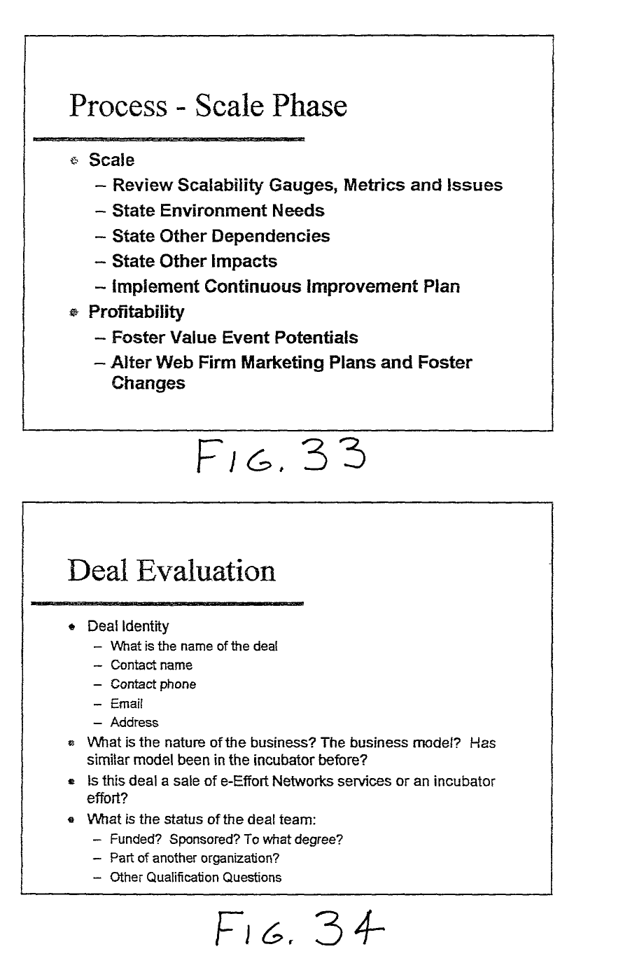

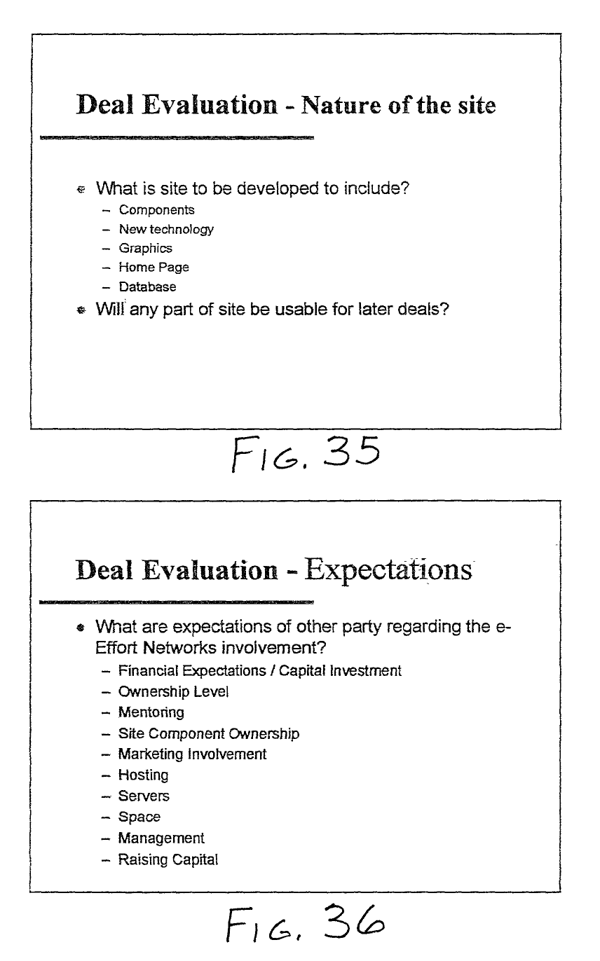

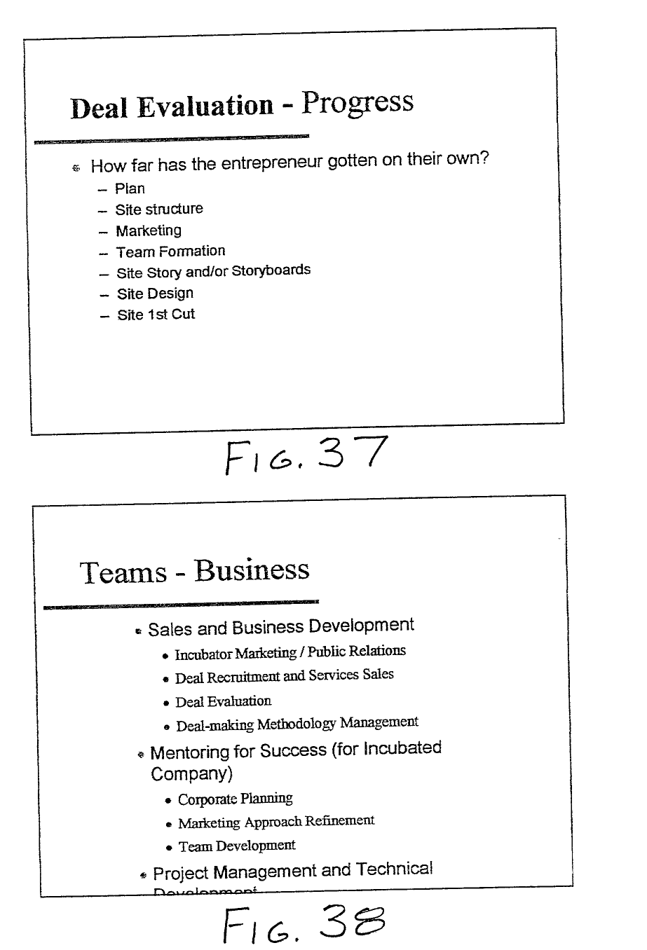

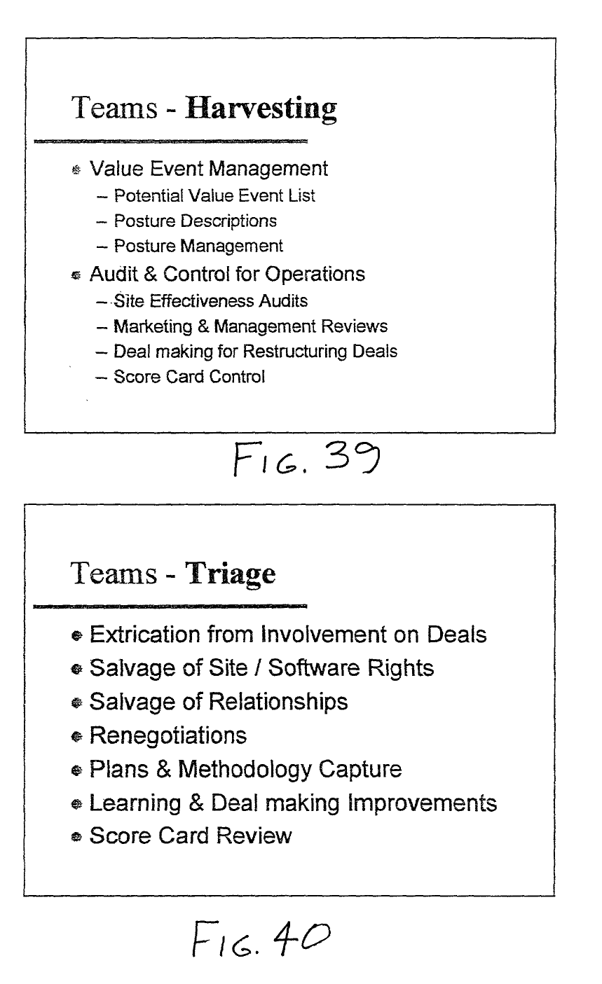

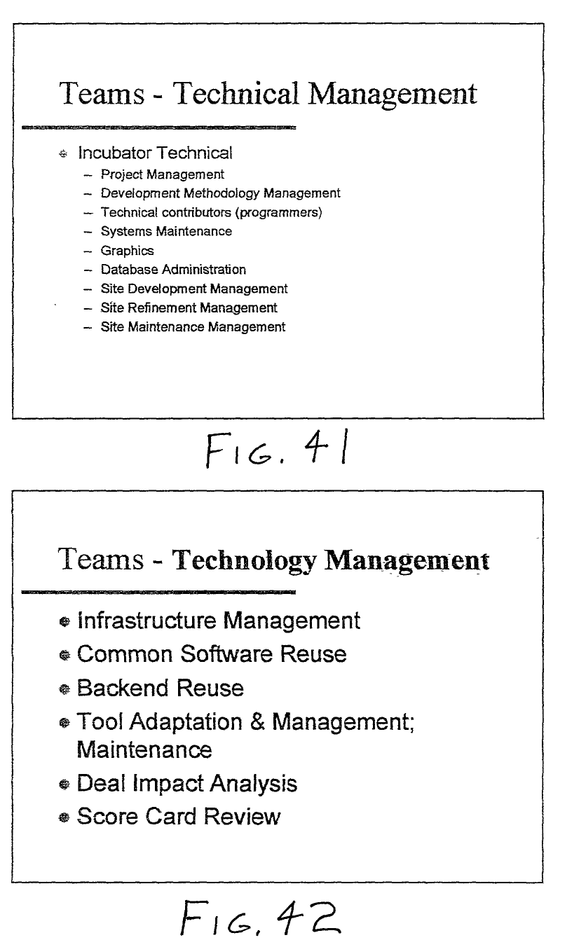

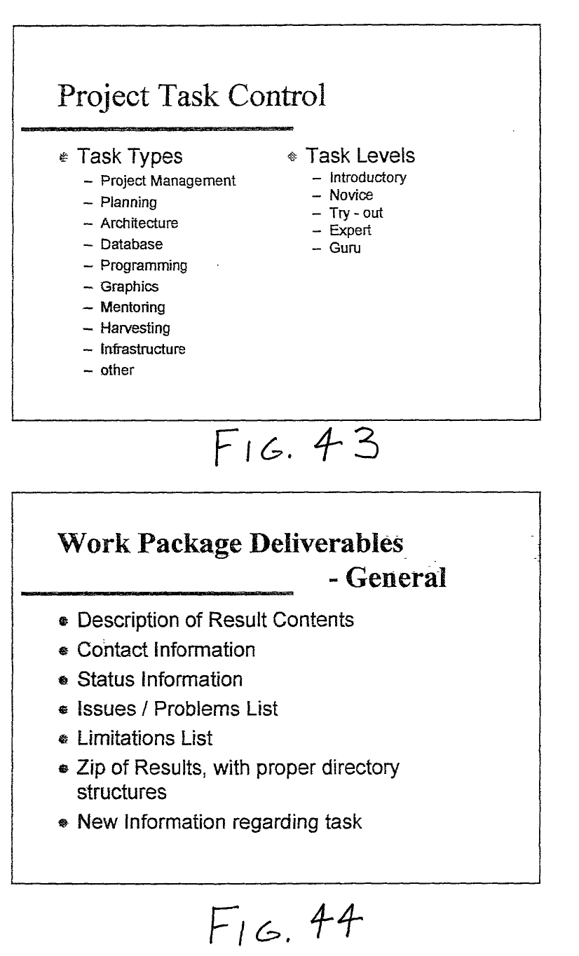

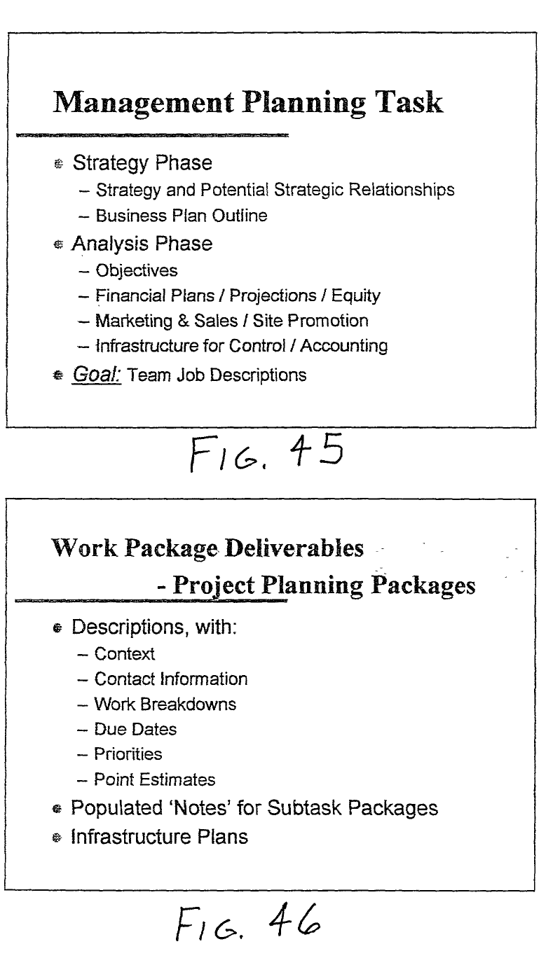

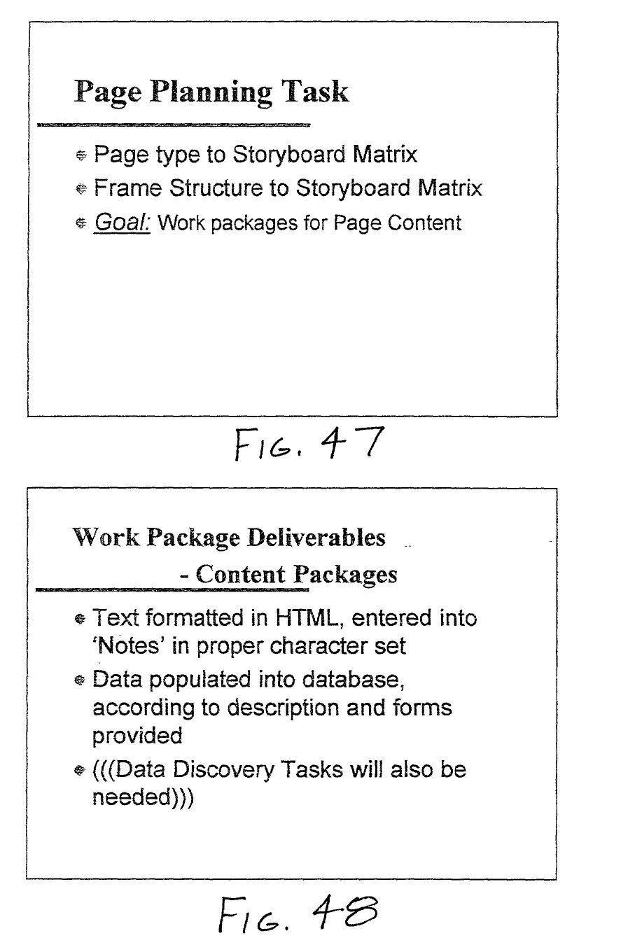

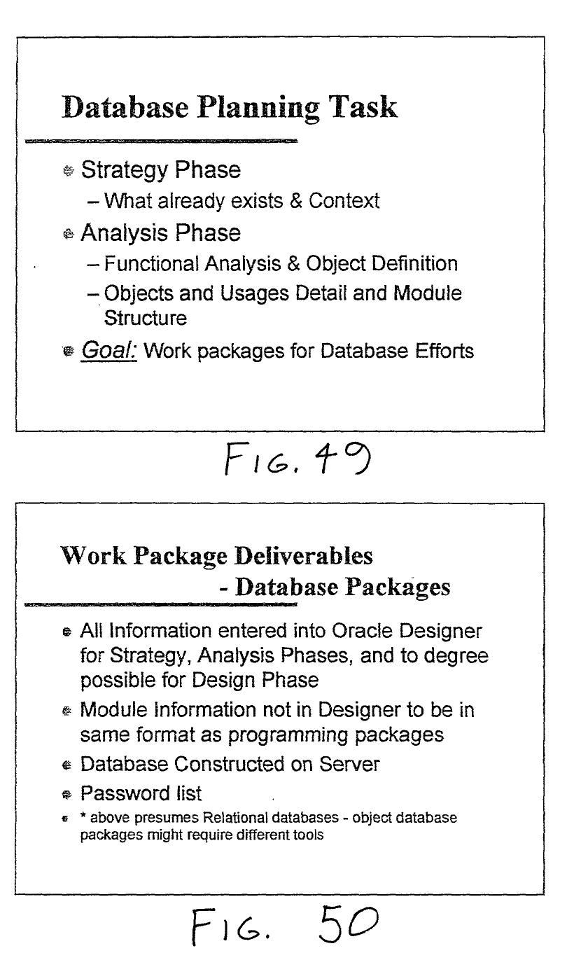

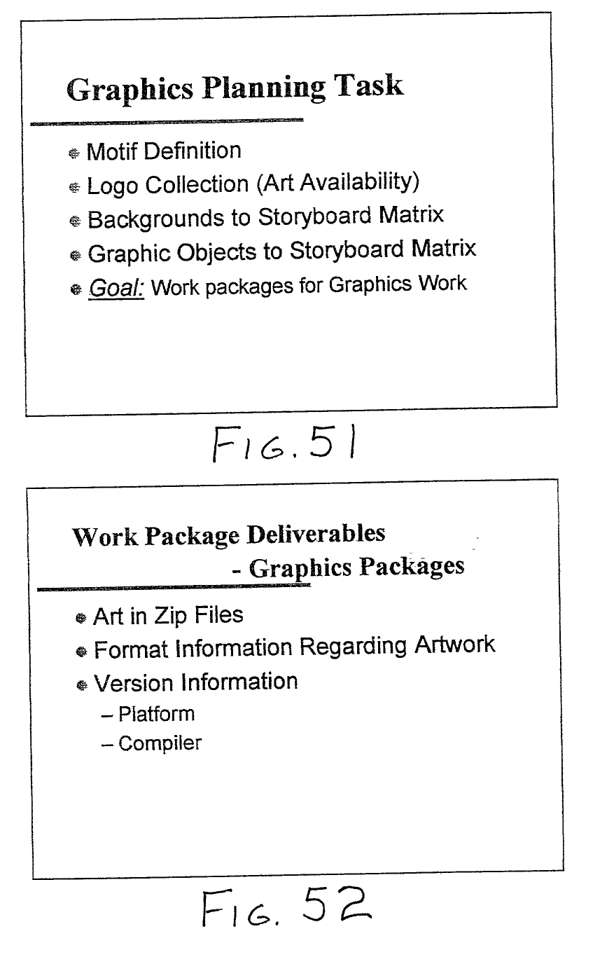

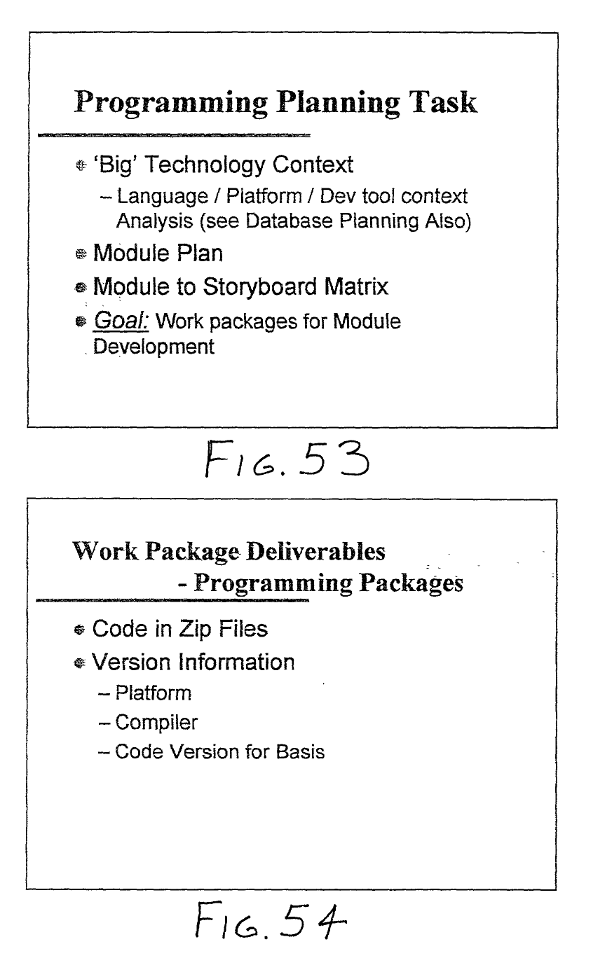

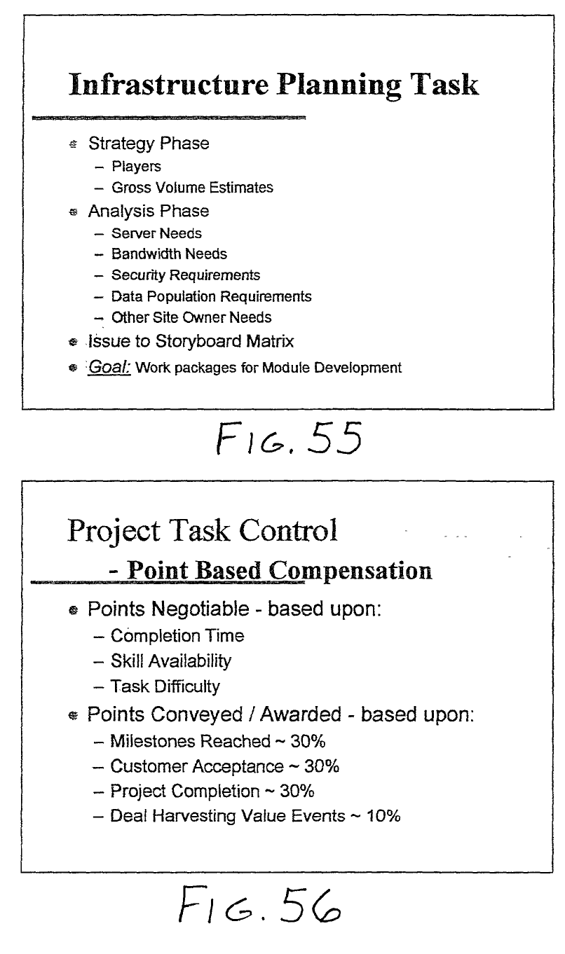

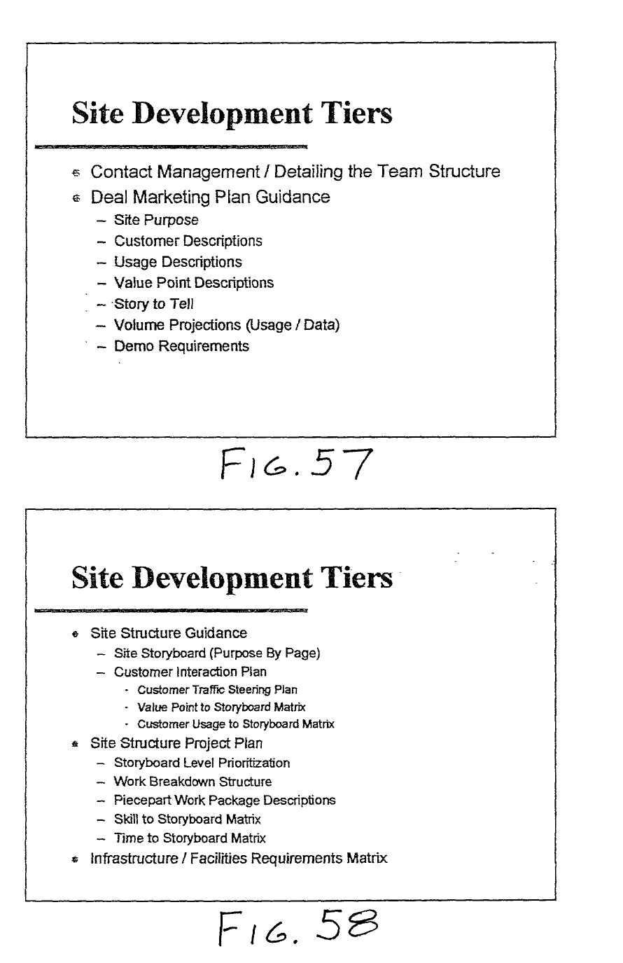

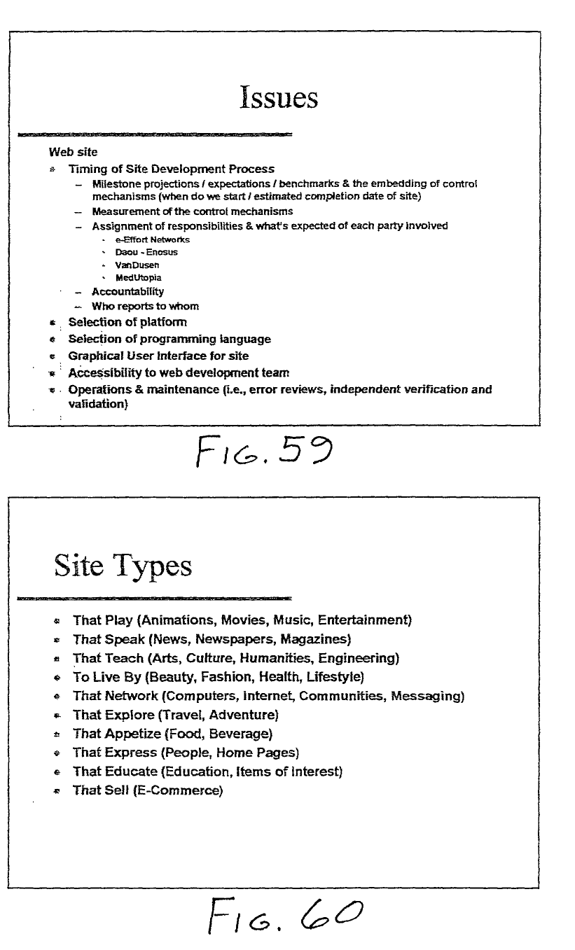

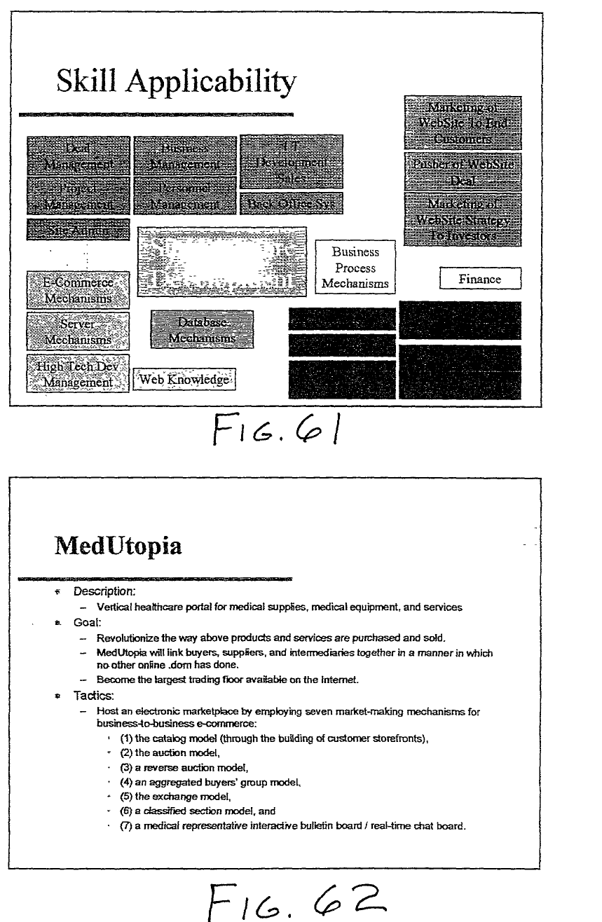

A Web presentation consists of one or more Web pages linked together in a meaningful way, which, as a whole, describes a body of information or creates an overall consistent effect (see FIG. 2.1).

A Web presentation is a collection of one or more Web pages.

7.30 Web Site

Each Web presentation is stored on a Web site, which is the actual machine on the Web that stores the presentation. Some people refer to the Web presentation and the Web site as the same thing; I like to keep them separate because a single Web site can contain many different presentations with very different purposes and developed by different people. Throughout the first week or so of this book you'll be learning how to develop Web presentations; later on you'll learn how to publish your presentation on an actual Web site.

A Web site is a system on the Internet containing one or more Web presentations.

7.31 Webtop

Webtop is the high-level user-interface environment that supports the different classes of participants involved in designing, building, and managing a Web business. At a higher level, the Webtop exposes each type of participant to a set of user interfaces for conducting their work.

7.32 Workflow and Process Automation

Workflow and Process Automation—a system for tying your business processes into your Web systems

Workflow and process automation services empower managers and developers to map business processes and business best-practices into the delivery of Web systems. Whether enforcing a process for creating a new press release or product promotion, or defining a set of processes for handling an incoming order or customer service request from an Internet site, workflow and process automation help businesses migrate to the Web efficiently.

Workflow Target Website Workflow planning tools provide interactive developers and business managers with a framework for mapping common multi-person, multi-step processes for creating and managing content and commerce assets.

Workflow services are best suited to process automation problems that involve multiple, simultaneous users, and that may involve tasks that have nothing to do with producing or managing the assets directly. For example, a workflow might include a task for an in-house lawyer to check into the trademark requirements for a piece of content going on a Web site.

Interactive developers collaborate with business managers to define the different processes and tasks needed for their Web business. For instance, they might define a set of tasks for creating images, news articles, and customer support articles. Likewise, they might define a set of tasks associated with commerce activities, such as creating a new product promotion or handling an incoming customer service request. Once these tasks are built (interactive developers actually write custom code to handle the execution of each task), business managers can visually assemble these into workflow templates, which are custom processes for the Web system.

Once this is done, business users or managers invoke a workflow template when they're ready to begin the work. The workflow process assigns specif

### e-Effort inc.

### (a proposed business name)

### Mission

Become the premier Internet company for a) emerging Internet companies that need small-to-medium sized web development, enterprise development, or other projects completed at low cost, or with no up-front charges, and b) individual developers and other professionals to perform tasks and receive compensation in the form of value points, redeemable for cash, merchandise, training, other services, or shareholder interests in e-Effort Equity Pools.

### Terminology

Clients—Entities which e-Effort has contracted to provide web-development, enterprise development or other project services.

Partner Clients—Clients which e-Effort has agreed to accept equity interests in the Client company as part, or all, of the compensation for e-Effort delivered services.

Incubator Clients—Partner Clients for which e-Effort is providing enterprise development and small business incubator services.

Associates—Entities accepted onto the e-Effort Register of Associates to perform e-Effort project tasks. Applicants to become Associates will meet specific qualification criteria, will be required to pass on-line technical and proficiency exams, and will provide verifiable references.

Register of Associates—The e-Effort list of registered Associates.

e-Effort Equity Pool—One or more fund pools of equity interests in Partner Clients. Each e-Effort Equity Pool will have the following attributes: a) fund assets consist of the major portions of Partner Client equity interests remitted to e-Effort as compensation for services; b) Associates and e-Effort inc. may be shareholders in any fund pool; c) Associate shares are not transferable and are not redeemable except through partial or full liquidation of pool assets, or by remittance to e-Effort in response to periodic offers of cash, merchandise, training, or other services.

Value Points—Value Points are awarded to Associates in compensation for completed, accepted project tasks where the Client will compensate e-Effort with non-equity interests. Value points are redeemable for a) cash, at periodic cash auctions; b) merchandise, training, or other services from an e-Effort catalog; or c) pre-defined, nominal cash amounts at any time. Value Points may be restricted to carry no right to share in an e-Effort Equity Pool.

Equity Points—Equity Points are awarded to Associates in compensation for completed, accepted project tasks where the Client will compensate e-Effort, in part, with equity interest in the Client entity. Equity Points may be retained as shares in an identified e-Effort Equity Pool, or may be redeemed to the same extent as Value Points.

### Major Features of the e-Effort System

Client Projects

Client projects are broken down into multiple levels of project tasks

Project tasks may consist of basic development work, consulting services, QA/QC of completed tasks, re-integration of tasks, task or project management, or any level or aspect of work to be done for the client

Compensation is negotiated with the client as cash and/or equity interests (subject to evaluation, due diligence, and acceptance by e-effort)

Performance of Tasks by Associates

Project tasks are posted on the e-effort Available Tasks web site

Project tasks may be identified as Value Point or Equity Point Tasks

Bids are solicited from Associates for performance of Tasks, in competition with other Associates

One or more bids may be accepted for each task

One associate may be awarded performance of a task, based upon a bidding competition for the right to do so

One or more Associates may simultaneously perform a task in competition with others, with the Associate first satisfactorily completing the task being awarded compensation

Task performance is assigned, controlled, and monitored through the Project/Task Management System, using web-based groupware and collaborative development processes

Task performance is monitored, assessed, and Value Points or Equity Points awarded

Associates can perform tasks using development and project management tools, and other resources, available through the web from e-Effort as an Application Service Provider (ASP).

Information relating to education, qualification, training, skills, experience, and performance on e-Effort tasks by associates will be recorded and maintained in an e-Effort database.

e-Effort Project/Task Management

Client projects are monitored and managed with the e-Effort project/task management system, utilizing groupware and other collaborative tools

The Client project management process includes a system for development and recordation into a project/task library system so that re-usable elements are recorded and retained for future use

The project management accounting system appropriately records compensation for work done, charges to the Client, payment to third parties for license fees, royalties, etc., overhead, and G&A

Tasks completed by associates are re-integrated into a completed project for delivery to the Client

As the e-Effort system matures, project/task management aspects such as task breakdown, QA/QC of completed tasks, and re-integration of completed tasks, will themselves become tasks suitable for bidding and performance by Associates with the appropriate experience and skills

Fees to Clients

Cash fees will be lower, due to competition by Associates bidding on tasks

Client's up-front fees can be low if Client equity is accepted as part of fee

Client equity interests assembled into equity pools, with shares available to e-Effort and Associates

Compensation to Associates

Compensation is initially paid in non-cash points

Points will be redeemable for a variety of items, including cash, merchandise, development tools, software products, training, services

Work is available to Associates to utilize otherwise idle time or time available at very low opportunity cost

Opportunity for Associates to receive desirable goods and services in lieu of cash

Opportunity for Associates to participate in the up-side potential of emerging companies

Sources of Associates

College and University students

Experts seeking after-hours or week-end work

Consultants

Moonlighters

“Stay-at-home” parents of small children

Retirees

Freelance workers

Other Significant Features

Creation of a unique type of security in the equity pool interests

Equity pool interests may represent what has sometimes been called “sweat equity”

The e-Effort system may result in new marketplace structures and paradigms for a) requesting effort (work), b) submitting effort (work) for compensation, c) multi-party collaborative development and tasking on a fully distributed basis

The e-Effort system may result in a framework for significant recordation, retention, and reuse of project plans, task distributions, personnel team structures, implementation schedules, QA/QC metrics, acceptance measures, etc.

The e-Effort system may result in a new paradigm for performing projects on a fully distributed, collaborative basis which may be completed without the need for any face-to-face contact by any of the various individuals involved

The e-Effort system may incorporate a database of completed tasks containing the reported evaluations of skills, abilities, and performance of the individual performers, so that these data may be made available to prospective employers and other interested parties

1. A method of contracting services, comprising:
creating an equity pool with a plurality of equity interests in one or more companies;
compensating an associate who has completed at least one milestone of a project with a portion of the equity pool.

2. A method of contracting services for a project, comprising:
parsing the project into project tasks;
soliciting bids on at least one of the project tasks;
awarding at least one of the project tasks to at least one associate based on a received bid from the at least one associate;
assessing the at least one associate's performance of the at least one project task; and
compensating the at least one associate based on the assessment and/or the received bid.

3. The method according to claim 2,
said compensating including awarding value points and/or equity points.

4. The method according to claim 3, further comprising:
redeeming the value points for cash, merchandise, one or more products, training, services, and/or prizes.

5. The method according to claim 3, further comprising:
creating an equity pool with a plurality of equity interests in one or more companies requesting project task completion.
redeeming the equity points for a share of the equity pool.

6. The method according to claim 3,
wherein the equity points are associated with a partial interest in an equity pool,
the method further comprising:
creating the equity pool with a plurality of equity interests in one or more companies requesting project task completion.

7. The method according to claim 2, further comprising:
integrating a plurality of the project tasks into at least a partially completed project

8. The method according to claim 7, further comprising:
said integrating step triggering a requirement to pay the least one associate for the at least partially completed project.

9. The method according to claim 3, further comprising:
rating each of the associate's performance. 0

10. The method according to claim 9, further comprising:
said awarding step awarding at least one future project task to the associate based on said rating step.

11. The method according to claim 9, further comprising:
increasing future task compensation by a bonus amount and/or a basic rate multiplier factor based on said rating step.

12. The method according to claim 2, wherein a plurality of associates attempt performance of the project task.,
said assessing including a time of completion of each associate and/or a quality assurance score.

13. A method of granting a sweat equity security, comprising:
creating an equity pool including a plurality of equity interests in one or more companies each of which has an associated project or project task;
receiving a service from at least one contributor that contributes to completion of at least a portion of one of the project tasks or projects;
awarding at least a portion of the equity pool based on at least partial completion of at least one of the project tasks or projects.

14. The method according to claim 13, further comprising:
evaluating the service received from the at least one contributor,
said awarding being at least partially based on said evaluation.

16. A security instrument, comprising:
an equity pool including a plurality of equity interests in one or more companies each of which has an associated project or project task; and
a security interest in the equity pool awarded based on at least partial completion of at least a portion of one of the project tasks or projects.
